(19) United States
(12) Patent Application Publication
(10) Pub. No.: US 2026/0239415 A1
(43) Pub. Date: Aug. 13, 2026

(54) EARLY PRECODING FOR INITIAL ACCESS

(71) Applicant: QUALCOMM Incorporated, San Diego, CA (US)

(72) Inventors: Yan ZHOU, San Diego, CA (US); In-Soo KIM, San Diego, CA (US); Jing JIANG, San Diego, CA (US)

(21) Appl. No.: 19/436,977

(22) Filed: Dec. 30, 2025

Related U.S. Application Data
(60) Provisional application No. 63/757,785, filed on Feb. 12, 2025.

(51) Int. Cl. H04W 74/00; H04W 74/08

(52) U.S. Cl. CPC H04W 74/006; H04W 74/08

(57) ABSTRACT

Methods, systems, and devices for wireless communications are described. In some cases, a user equipment (UE) may receive, from a network entity while in an idle or inactive state, configuration information associated with one or more reference signals. Additionally, the UE, the network entity, or both, may communicate, in accordance with the configuration information, the one or more reference signals prior to at least a first subset of a set of messages associated with an initial access procedure. Thus, the UE, the network entity, or both, may determine one or more precoders (e.g., an uplink precoder, a downlink precoder, or both) based on one or more channel measurements of the one or more reference signals and may communicate at least a second subset of the plurality of messages associated with the initial access procedure in accordance with one or more precoders.

### CROSS REFERENCE

The present Application for Patent claims benefit of U.S. Provisional Patent Application No. 63/757,785 by ZHOU et al., entitled “EARLY PRECODING FOR INITIAL ACCESS,” filed Feb. 12, 2025, assigned to the assignee hereof, and expressly incorporated herein.

### FIELD OF TECHNOLOGY

The following relates to wireless communications, including early precoding for initial access.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support one or more coverage enhancements schemes for one or more initial access channels, where the one or more coverage enhancement schemes may be based on repetition of the one or more initial access channels. However, increasing a quantity of repetitions of the one or more initial access channels (e.g., compared to no repetitions) may result in increased signaling overhead and reduction in network energy savings.

### SUMMARY

The systems, methods, and devices of this disclosure each have several innovative aspects, no single one of which is solely responsible for the desirable attributes disclosed herein.

Some wireless communications systems may support one or more initial access procedures (e.g., random access procedures) to enable a user equipment (UE) to initiate communications with a network entity. For example, the UE may support a two-step random access procedure, a four-step random access procedure, or both. However, one or more coverage bottlenecks may occur during an initial access procedure. For example, a network entity may broadcast one or more downlink messages of the initial access procedure via a physical downlink control channel (PDCCH), a physical downlink shared channel (PDSCH), or both, in accordance with a precoder that may result in a lower communication performance than may be supported by the PDSCH, the PDCCH, or both (e.g., in accordance with a sub-optimal precoder). Additionally, or alternatively, a link budget for one or more uplink messages of the initial access procedure (e.g., Msg3, Msg4 acknowledgment (ACK)) may degrade when the network entity is unable to combine multiple digital ports.

Accordingly, techniques described herein may enable a UE, a network entity, or both, to determine one or more precoders (e.g., an uplink precoder, a downlink precoder, or both) prior to completion of (e.g., before and/or during) an initial access procedure, which may result in improved coverage, reliability, spectrum efficiency, or any combination thereof (e.g., as compared to determining the one or more precoders after completion of the initial access procedure). In some cases, the UE, the network entity, or both, may determine the one or more precoders based on one or more channel state information reference signals (CSI-RS). For example, the UE may receive the one or more CSI-RS prior to a first uplink message (e.g., Msg1, MsgA) of the initial access procedure and may determine an uplink precoder based on measurement of the one or more CSI-RS. Additionally, the network entity may determine a downlink precoder based on measurement of one or more uplink messages of the initial access procedure (e.g., Msg1, MsgA, Msg3), based on a CSI report transmitted by the UE via the first uplink message (e.g., or via Msg3), or both.

Additionally, or alternatively, the UE, the network entity, or both, may determine the one or more precoders based on one or more sounding reference signals (SRSs). For example, the UE may transmit the one or more SRSs after at least the first uplink message of the initial access procedure and the network entity may determine the downlink precoder based on the one or more SRSs. In some cases, the UE may transmit the one or more SRSs after the first uplink message (e.g., Msg1, MsgA) of the initial access procedure, where the first uplink message indicates one or more parameters associated with the one or more SRSs. In some other cases, the UE may transmit the one or more SRSs after a second uplink message (e.g., Msg3) of the initial access procedure, where a first downlink message (e.g., Msg2, MsgB) of the initial access procedure indicates one or more parameters associated with the one or more SRSs. In either case, the UE may additionally determine the uplink precoder based on an indication of the uplink precoder from the network entity (e.g., via Msg2 or Msg 4), based on a preceding downlink message (e.g., Msg2 or Msg4), or both.

Additionally, or alternatively, the UE, the network entity, or both, may determine the one or more precoders based on the one or more SRSs and the one or more CSI-RSs. That is, the network entity may transmit the one or more CSI-RSs before the first message of the initial access procedure and the UE may determine the uplink precoder based on the one or more CSI-RSs. Thus, the UE may apply the uplink precoder to transmission of the first message of the initial access procedure and, after transmission of the first message, may transmit the one or more SRSs. Thus, the network entity may determine the downlink precoder based on the one or more SRSs.

Thus, the UE, the network entity, or both, may communicate (e.g., transmit or receive) one or more messages of the initial access procedure based on the uplink precoder, the downlink precoder, or both, determined prior to completion of the initial access procedure based on determining the uplink precoder, the downlink precoder, or both, prior to completion of the initial access procedure.

A method for wireless communications by a user equipment (UE) is described. The method may include receiving, while the UE is in an idle or inactive state, configuration information associated with one or more reference signals, communicating, in accordance with the configuration information, the one or more reference signals prior to at least a first subset of a set of multiple messages associated with an initial access procedure, and communicating at least a second subset of the set of multiple messages associated with the initial access procedure in accordance with one or more precoders, where the one or more precoders are based on one or more channel measurements of the one or more reference signals.

A UE for wireless communications is described. The UE may include one or more memories storing processor executable code, and one or more processors coupled with the one or more memories. The one or more processors may individually or collectively be operable to execute the code to cause the UE to receive, while the UE is in an idle or inactive state, configuration information associated with one or more reference signals, communicate, in accordance with the configuration information, the one or more reference signals prior to at least a first subset of a set of multiple messages associated with an initial access procedure, and communicate at least a second subset of the set of multiple messages associated with the initial access procedure in accordance with one or more precoders, where the one or more precoders are based on one or more channel measurements of the one or more reference signals.

Another UE for wireless communications is described. The UE may include means for receiving, while the UE is in an idle or inactive state, configuration information associated with one or more reference signals, means for communicating, in accordance with the configuration information, the one or more reference signals prior to at least a first subset of a set of multiple messages associated with an initial access procedure, and means for communicating at least a second subset of the set of multiple messages associated with the initial access procedure in accordance with one or more precoders, where the one or more precoders are based on one or more channel measurements of the one or more reference signals.

A non-transitory computer-readable medium storing code for wireless communications is described. The code may include instructions executable by one or more processors to receive, while the UE is in an idle or inactive state, configuration information associated with one or more reference signals, communicate, in accordance with the configuration information, the one or more reference signals prior to at least a first subset of a set of multiple messages associated with an initial access procedure, and communicate at least a second subset of the set of multiple messages associated with the initial access procedure in accordance with one or more precoders, where the one or more precoders are based on one or more channel measurements of the one or more reference signals.

In some examples of the method, UEs, and non-transitory computer-readable medium described herein, communicating the one or more reference signals prior to at least the first subset of the set of multiple messages associated with the initial access procedure may include operations, features, means, or instructions for receiving the one or more channel state information reference signals (CSI-RSs) prior to all of the set of multiple messages associated with the initial access procedure.

In some examples of the method, UEs, and non-transitory computer-readable medium described herein, the one or more precoders includes an uplink precoder and the second subset of the set of multiple messages associated with the initial access procedure includes a first uplink message of the initial access procedure, a second uplink message of the initial access procedure, or both.

Some examples of the method, UEs, and non-transitory computer-readable medium described herein may further include operations, features, means, or instructions for receiving an indication of whether the UE may be to apply the uplink precoder to the first uplink message of the initial access procedure, the second uplink message of the initial access procedure, or both, where the second subset of the set of multiple messages includes the first uplink message of the initial access procedure, the second uplink message of the initial access procedure, or both, based on the indication.

In some examples of the method, UEs, and non-transitory computer-readable medium described herein, the one or more precoders includes a downlink precoder and the second subset of the set of multiple messages associated with the initial access procedure includes a first downlink message of the initial access procedure, a second downlink message of the initial access procedure, or both.

In some examples of the method, UEs, and non-transitory computer-readable medium described herein, the downlink precoder may be based on one or more additional channel measurements associated with a first uplink message of the initial access procedure, a second uplink message of the initial access procedure, or both.

Some examples of the method, UEs, and non-transitory computer-readable medium described herein may further include operations, features, means, or instructions for transmitting a report indicative of the one or more channel measurements associated with the one or more CSI-RSs via a first uplink message of the initial access procedure, a second uplink message of the initial access procedure, or both, where the downlink precoder may be based on the one or more channel measurements.

In some examples of the method, UEs, and non-transitory computer-readable medium described herein, the report may be indicative of the one or more channel measurements based on the report include one or more channel quality indicators (CQIs), one or more precoding matrix indices (PMIs), one or more ranks, one or more layer indicators, or any combination thereof.

In some examples of the method, UEs, and non-transitory computer-readable medium described herein, transmission of the report may be in accordance with one or more parameters and the one or more parameters include one or more metrics to be reported, a PMI codebook type, one or more restrictions associated with the one or more metrics to be reported, a reported bandwidth, one or more reporting resources, reporting time behavior, or any combination thereof.

Some examples of the method, UEs, and non-transitory computer-readable medium described herein may further include operations, features, means, or instructions for transmitting a small data transmission (SDT) in accordance with an uplink precoder of the one or more precoders based on receiving the one or more reference signals prior to the SDT.

In some examples of the method, UEs, and non-transitory computer-readable medium described herein, the SDT includes a first subset of uplink data and the method, apparatuses, and non-transitory computer-readable medium may include further operations, features, means, or instructions for transmitting, after the SDT, a second subset of the uplink data in accordance with the uplink precoder based on the SDT including the first subset of the uplink data.

In some examples of the method, UEs, and non-transitory computer-readable medium described herein, the SDT includes a radio resource control (RRC) resume request, a buffer status report (BSR), or both.

In some examples of the method, UEs, and non-transitory computer-readable medium described herein, the one or more reference signals includes one or more CSI-RSs and the method, apparatuses, and non-transitory computer-readable medium may include further operations, features, means, or instructions for transmitting, after the SDT, one or more sounding reference signals (SRSs), where the one or more precoders includes a downlink precoder based on the one or more SRSs.

In some examples of the method, UEs, and non-transitory computer-readable medium described herein, communicating the one or more reference signals prior to at least the first subset of the set of multiple messages associated with the initial access procedure may include operations, features, means, or instructions for transmitting the one or more SRSs after at least a first uplink message of the initial access procedure.

In some examples of the method, UEs, and non-transitory computer-readable medium described herein, at least the second subset of the set of multiple messages associated with the initial access procedure includes a second uplink message of the initial access procedure, and one or more downlink messages of the initial access procedure.

In some examples of the method, UEs, and non-transitory computer-readable medium described herein, the one or more precoders includes an uplink precoder based on the one or more channel measurements of the one or more SRSs and a first downlink message of the one or more downlink messages includes an indication of the uplink precoder to be used for transmission of the second uplink message of the initial access procedure.

In some examples of the method, UEs, and non-transitory computer-readable medium described herein, the one or more precoders includes an uplink precoder based on a first downlink message from the one or more downlink messages of the initial access procedure and based on the first uplink message and the first downlink message being associated with a same bandwidth.

In some examples of the method, UEs, and non-transitory computer-readable medium described herein, the one or more precoders includes a downlink precoder based on the one or more SRSs and based on the UE supporting maximum ratio combining and reception of the one or more downlink messages may be in accordance with the downlink precoder.

In some examples of the method, UEs, and non-transitory computer-readable medium described herein, the first uplink message of the initial access procedure includes an indication of the configuration information, the configuration information may be indicative of one or more parameters associated with the one or more SRSs, and the one or more parameters include a starting time, a resource block (RB) range, a comb offset, a root sequence index, a cyclic shift per port, or any combination thereof.

In some examples of the method, UEs, and non-transitory computer-readable medium described herein, transmitting the one or more SRSs after at least the first uplink message of the initial access procedure may include operations, features, means, or instructions for transmitting the one or more SRSs after at least a first downlink message of the initial access procedure, where the first downlink message includes the configuration information associated with one or more SRSs.

In some examples of the method, UEs, and non-transitory computer-readable medium described herein, the one or more precoders includes a downlink precoder based on the one or more SRSs and at least the second subset of the set of multiple messages associated with the initial access procedure includes at least a second downlink message of the initial access procedure.

In some examples of the method, UEs, and non-transitory computer-readable medium described herein, the one or more precoders includes an uplink precoder based on the one or more channel measurements of the one or more SRSs and a second downlink message of the initial access procedure includes an indication of the uplink precoder.

In some examples of the method, UEs, and non-transitory computer-readable medium described herein, the one or more precoders includes an uplink precoder based on a second downlink message of the initial access procedure.

In some examples of the method, UEs, and non-transitory computer-readable medium described herein, the first downlink message of the initial access procedure, a second uplink message of the initial access procedure, or both, includes an indication of the configuration information, the configuration information may be indicative of one or more parameters associated with the one or more SRSs, and the one or more parameters include a starting time, a RB range, a comb offset, a root sequence index, a cyclic shift per port, or any combination thereof.

In some examples of the method, UEs, and non-transitory computer-readable medium described herein, communicating the one or more reference signals prior to at least the first subset of the set of multiple messages associated with the initial access procedure may include operations, features, means, or instructions for receiving the one or more CSI-RSs prior to a first uplink message of the initial access procedure, where the one or more precoders includes an uplink precoder based on the one or more CSI-RSs and transmitting the one or more SRSs after the first uplink message of the initial access procedure, where the one or more precoders includes an downlink precoder based on the one or more SRSs.

In some examples of the method, UEs, and non-transitory computer-readable medium described herein, a set of time and frequency resources associated with the one or more SRSs may be common to a set of multiple UEs, including at least the UE.

In some examples of the method, UEs, and non-transitory computer-readable medium described herein, the one or more SRSs may be transmitted via a first slot and an offset between the first slot and an end of the first uplink message satisfies a threshold offset.

In some examples of the method, UEs, and non-transitory computer-readable medium described herein, transmission of the one or more SRSs may be based on a highest reference signal receive power (RSRP) associated with one or more synchronization signal blocks exceeding a threshold RSRP, based on a repetition number associated with the first uplink message exceeding a threshold number, or both.

In some examples of the method, UEs, and non-transitory computer-readable medium described herein, the configuration information includes an indication of one or more first parameters associated with the one or more reference signals and the one or more first parameters include a time behavior associated with the one or more reference signals, one or more resource sets associated with the one or more reference signals, a quantity of resources per resource set, or any combination thereof.

In some examples of the method, UEs, and non-transitory computer-readable medium described herein, the configuration information further includes one or more second parameters associated with each resource set within the one or more resource sets and the one or more second parameters include a subcarrier spacing (SCS), a resource set type, a power offset, a prioritization rule associated with one or more other signals, an availability indicator associated with a time window, timing advance (TA) information, one or more power control parameters, a resource set type, or any combination thereof.

In some examples of the method, UEs, and non-transitory computer-readable medium described herein, the configuration information further includes one or more second parameters associated with each resource in the resource set and the one or more second parameters include a total quantity of ports, a port index assignment, a time-frequency dimension per code division multiplexing (CDM) group, a multiplexed port number per CDM group, a time-frequency location per CDM group in a corresponding slot, a sequence identifier, a scrambling identifier, a first quasi-co-location (QCL) source, a first reference signal used to determine a receive spatial filter, a comb offset, a root sequence index, a cyclic shift, a total quantity of symbols, a symbol repetition factor, one or more symbol locations, a RB range, a frequency hopping pattern, one or more time-frequency locations per repetition, a second QCL source used to determine a transmit spatial filter, one or more time offsets, or any combination thereof.

In some examples of the method, UEs, and non-transitory computer-readable medium described herein, the configuration information may be received via a system information block (SIB), a master information block (MIB), or both.

Some examples of the method, UEs, and non-transitory computer-readable medium described herein may further include operations, features, means, or instructions for transmitting a capability message indicative associated with determination of the one or more precoders based on the one or more reference signals.

In some examples of the method, UEs, and non-transitory computer-readable medium described herein, the capability message indicates a threshold quantity of ports supported by the UE, a threshold quantity of resources supported by the UE, one or more metrics supported by the UE, or any combination thereof.

In some examples of the method, UEs, and non-transitory computer-readable medium described herein, the one or more precoders may be determined in accordance with a capability of the UE.

In some examples of the method, UEs, and non-transitory computer-readable medium described herein, communication of the one or more reference signals in accordance with the configuration information based on the UE supporting the configuration information.

A method for wireless communications by a network entity is described. The method may include outputting, to a UE that is in an idle or inactive state, configuration information associated with one or more reference signals, communicating, in accordance with the configuration information, the one or more reference signals prior to at least a first subset of a set of multiple messages associated with an initial access procedure, and communicating at least a second subset of the set of multiple messages associated with the initial access procedure in accordance with one or more precoders, where the one or more precoders are based on one or more channel measurements of the one or more reference signals.

A network entity for wireless communications is described. The network entity may include one or more memories storing processor executable code, and one or more processors coupled with the one or more memories. The one or more processors may individually or collectively be operable to execute the code to cause the network entity to output, to a UE that is in an idle or inactive state, configuration information associated with one or more reference signals, communicate, in accordance with the configuration information, the one or more reference signals prior to at least a first subset of a set of multiple messages associated with an initial access procedure, and communicate at least a second subset of the set of multiple messages associated with the initial access procedure in accordance with one or more precoders, where the one or more precoders are based on one or more channel measurements of the one or more reference signals.

Another network entity for wireless communications is described. The network entity may include means for outputting, to a UE that is in an idle or inactive state, configuration information associated with one or more reference signals, means for communicating, in accordance with the configuration information, the one or more reference signals prior to at least a first subset of a set of multiple messages associated with an initial access procedure, and means for communicating at least a second subset of the set of multiple messages associated with the initial access procedure in accordance with one or more precoders, where the one or more precoders are based on one or more channel measurements of the one or more reference signals.

A non-transitory computer-readable medium storing code for wireless communications is described. The code may include instructions executable by one or more processors to output, to a UE that is in an idle or inactive state, configuration information associated with one or more reference signals, communicate, in accordance with the configuration information, the one or more reference signals prior to at least a first subset of a set of multiple messages associated with an initial access procedure, and communicate at least a second subset of the set of multiple messages associated with the initial access procedure in accordance with one or more precoders, where the one or more precoders are based on one or more channel measurements of the one or more reference signals.

In some examples of the method, network entities, and non-transitory computer-readable medium described herein, communicating the one or more reference signals prior to at least the first subset of the set of multiple messages associated with the initial access procedure may include operations, features, means, or instructions for outputting the one or more CSI-RSs prior to all of the set of multiple messages associated with the initial access procedure.

In some examples of the method, network entities, and non-transitory computer-readable medium described herein, the one or more precoders includes an uplink precoder and the second subset of the set of multiple messages associated with the initial access procedure includes a first uplink message of the initial access procedure, a second uplink message of the initial access procedure, or both.

Some examples of the method, network entities, and non-transitory computer-readable medium described herein may further include operations, features, means, or instructions for transmitting an indication of whether the UE may be to apply the uplink precoder to the first uplink message of the initial access procedure, the second uplink message of the initial access procedure, or both, where the second subset of the set of multiple messages includes the first uplink message of the initial access procedure, the second uplink message of the initial access procedure, or both, based on the indication.

In some examples of the method, network entities, and non-transitory computer-readable medium described herein, the one or more precoders includes a downlink precoder and the second subset of the set of multiple messages associated with the initial access procedure includes a first downlink message of the initial access procedure, a second downlink message of the initial access procedure, or both.

In some examples of the method, network entities, and non-transitory computer-readable medium described herein, the downlink precoder may be based on one or more additional channel measurements associated with a first uplink message of the initial access procedure, a second uplink message of the initial access procedure, or both.

Some examples of the method, network entities, and non-transitory computer-readable medium described herein may further include operations, features, means, or instructions for receiving a report indicative of the one or more channel measurements associated with the one or more CSI-RSs via a first uplink message of the initial access procedure, a second uplink message of the initial access procedure, or both, where the downlink precoder may be based on the one or more channel measurements.

In some examples of the method, network entities, and non-transitory computer-readable medium described herein, the report may be indicative of the one or more channel measurements based on the report include one or more CQIs, one or more PMIs, one or more ranks, one or more layer indicators, or any combination thereof.

In some examples of the method, network entities, and non-transitory computer-readable medium described herein, reception of the report may be in accordance with one or more parameters and the one or more parameters include one or more metrics to be reported, a PMI codebook type, one or more restrictions associated with the one or more metrics to be reported, a reported bandwidth, one or more reporting resources, reporting time behavior, or any combination thereof.

Some examples of the method, network entities, and non-transitory computer-readable medium described herein may further include operations, features, means, or instructions for obtaining an SDT in accordance with an uplink precoder of the one or more precoders based on receiving the one or more reference signals prior to the SDT.

Some examples of the method, network entities, and non-transitory computer-readable medium described herein may further include operations, features, means, or instructions for obtaining, after the SDT, a second subset of the uplink data in accordance with the uplink precoder based on the SDT including the first subset of the uplink data.

In some examples of the method, network entities, and non-transitory computer-readable medium described herein, the SDT includes an RRC resume request, a BSR, or both.

In some examples of the method, network entities, and non-transitory computer-readable medium described herein, the one or more reference signals includes one or more CSI-RSs and the method, apparatuses, and non-transitory computer-readable medium may include further operations, features, means, or instructions for obtaining, after the SDT, one or more SRSs, where the one or more precoders includes a downlink precoder based on the one or more SRSs.

In some examples of the method, network entities, and non-transitory computer-readable medium described herein, communicating the one or more reference signals prior to at least the first subset of the set of multiple messages associated with the initial access procedure may include operations, features, means, or instructions for obtaining the one or more SRSs after at least a first uplink message of the initial access procedure.

In some examples of the method, network entities, and non-transitory computer-readable medium described herein, at least the second subset of the set of multiple messages associated with the initial access procedure includes a second uplink message of the initial access procedure, and one or more downlink messages of the initial access procedure.

In some examples of the method, network entities, and non-transitory computer-readable medium described herein, the one or more precoders includes an uplink precoder based on the one or more channel measurements of the one or more SRSs and a first downlink message of the one or more downlink messages includes an indication of the uplink precoder to be used for transmission of the second uplink message of the initial access procedure.

In some examples of the method, network entities, and non-transitory computer-readable medium described herein, the one or more precoders includes an uplink precoder based on a first downlink message from the one or more downlink messages of the initial access procedure and based on the first uplink message and the first downlink message being associated with a same bandwidth.

In some examples of the method, network entities, and non-transitory computer-readable medium described herein, the one or more precoders includes a downlink precoder based on the one or more SRSs and based on the UE supporting maximum ratio combining and reception of the one or more downlink messages may be in accordance with the downlink precoder.

In some examples of the method, network entities, and non-transitory computer-readable medium described herein, obtaining the one or more SRSs after at least the first uplink message of the initial access procedure may include operations, features, means, or instructions for obtaining the one or more SRSs after at least a first downlink message of the initial access procedure, where the first downlink message includes the configuration information associated with one or more SRSs.

In some examples of the method, network entities, and non-transitory computer-readable medium described herein, the one or more precoders includes a downlink precoder based on the one or more SRSs and at least the second subset of the set of multiple messages associated with the initial access procedure includes at least a second downlink message of the initial access procedure.

In some examples of the method, network entities, and non-transitory computer-readable medium described herein, the one or more precoders includes an uplink precoder based on the one or more channel measurements of the one or more SRSs and a second downlink message of the initial access procedure includes an indication of the uplink precoder.

In some examples of the method, network entities, and non-transitory computer-readable medium described herein, the one or more precoders includes an uplink precoder based on a second downlink message of the initial access procedure.

In some examples of the method, network entities, and non-transitory computer-readable medium described herein, the first downlink message of the initial access procedure, a second uplink message of the initial access procedure, or both, includes an indication of the configuration information, the configuration information may be indicative of one or more parameters associated with the one or more SRSs, and the one or more parameters include a starting time, a RB range, a comb offset, a root sequence index, a cyclic shift per port, or any combination thereof.

In some examples of the method, network entities, and non-transitory computer-readable medium described herein, communicating the one or more reference signals prior to at least the first subset of the set of multiple messages associated with the initial access procedure may include operations, features, means, or instructions for outputting the one or more CSI-RSs prior to a first uplink message of the initial access procedure, where the one or more precoders includes an uplink precoder based on the one or more CSI-RSs and obtaining the one or more SRSs after the first uplink message of the initial access procedure, where the one or more precoders includes an downlink precoder based on the one or more SRSs.

In some examples of the method, network entities, and non-transitory computer-readable medium described herein, a set of time and frequency resources associated with the one or more SRSs may be common to a set of multiple UEs, including at least the UE.

In some examples of the method, network entities, and non-transitory computer-readable medium described herein, the one or more SRSs may be transmitted via a first slot and an offset between the first slot and an end of the first uplink message satisfies a threshold offset.

In some examples of the method, network entities, and non-transitory computer-readable medium described herein, reception of the one or more SRSs may be based on a highest RSRP associated with one or more synchronization signal blocks exceeding a threshold RSRP, based on a repetition number associated with the first uplink message exceeding a threshold number, or both.

In some examples of the method, network entities, and non-transitory computer-readable medium described herein, the configuration information includes an indication of one or more first parameters associated with the one or more reference signals and the one or more first parameters include a time behavior associated with the one or more reference signals, one or more resource sets associated with the one or more reference signals, a quantity of resources per resource set, or any combination thereof.

In some examples of the method, network entities, and non-transitory computer-readable medium described herein, the configuration information further includes one or more second parameters associated with each resource set within the one or more resource sets and the one or more second parameters include an SCS, a resource set type, a power offset, a prioritization rule associated with one or more other signals, an availability indicator associated with a time window, TA information, one or more power control parameters, a resource set type, or any combination thereof.

In some examples of the method, network entities, and non-transitory computer-readable medium described herein, the configuration information further includes one or more second parameters associated with each resource in the resource set and the one or more second parameters include a total quantity of ports, a port index assignment, a time-frequency dimension per CDM group, a multiplexed port number per CDM group, a time-frequency location per CDM group in a corresponding slot, a sequence identifier, a scrambling identifier, a first QCL source, a first reference signal used to determine a receive spatial filter, a comb offset, a root sequence index, a cyclic shift, a total quantity of symbols, a symbol repetition factor, one or more symbol locations, a RB range, a frequency hopping pattern, one or more time-frequency locations per repetition, a second QCL source used to determine a transmit spatial filter, one or more time offsets, or any combination thereof.

In some examples of the method, network entities, and non-transitory computer-readable medium described herein, the configuration information may be received via a SIB, a MIB, or both.

Some examples of the method, network entities, and non-transitory computer-readable medium described herein may further include operations, features, means, or instructions for obtaining a capability message indicative associated with determination of the one or more precoders based on the one or more reference signals.

In some examples of the method, network entities, and non-transitory computer-readable medium described herein, the capability message indicates a threshold quantity of ports supported by the UE, a threshold quantity of resources supported by the UE, one or more metrics supported by the UE, or any combination thereof.

In some examples of the method, network entities, and non-transitory computer-readable medium described herein, the one or more precoders may be determined in accordance with a capability of the UE.

In some examples of the method, network entities, and non-transitory computer-readable medium described herein, communication of the one or more reference signals in accordance with the configuration information based on the UE supporting the configuration information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports early precoding for initial access in accordance with one or more aspects of the present disclosure.

FIGS. 2A and 2B show examples of wireless communications systems that supports early precoding for initial access in accordance with one or more aspects of the present disclosure.

FIGS. 3A and 3B show examples of wireless communications systems that supports early precoding for initial access in accordance with one or more aspects of the present disclosure.

FIGS. 4A and 4B show examples of wireless communications systems supports early precoding for initial access in accordance with one or more aspects of the present disclosure.

FIG. 5 shows an example of a process flow that supports early precoding for initial access in accordance with one or more aspects of the present disclosure.

FIGS. 6 and 7 show block diagrams of devices that support early precoding for initial access in accordance with one or more aspects of the present disclosure.

FIG. 8 shows a block diagram of a communications manager that supports early precoding for initial access in accordance with one or more aspects of the present disclosure.

FIG. 9 shows a diagram of a system including a device that supports early precoding for initial access in accordance with one or more aspects of the present disclosure.

FIGS. 10 and 11 show block diagrams of devices that support early precoding for initial access in accordance with one or more aspects of the present disclosure.

FIG. 12 shows a block diagram of a communications manager that supports early precoding for initial access in accordance with one or more aspects of the present disclosure.

FIG. 13 shows a diagram of a system including a device that supports early precoding for initial access in accordance with one or more aspects of the present disclosure.

FIGS. 14 and 15 show flowcharts illustrating methods that support early precoding for initial access in accordance with one or more aspects of the present disclosure.

### DETAILED DESCRIPTION

Some wireless communications systems may support one or more initial access procedures (e.g., random access procedures) to enable a user equipment (UE) to initiate communications with a network entity. For example, the UE may support a two-step random access procedure, a four-step random access procedure, or both. However, one or more coverage bottlenecks may occur during an initial access procedure. For example, a network entity may broadcast one or more downlink messages of the initial access procedure via a physical downlink control channel (PDCCH), a physical downlink shared channel (PDSCH), or both, in accordance with a precoder that may result in a lower communication performance than may be supported by the PDSCH, the PDCCH, or both (e.g., in accordance with a sub-optimal precoder). Additionally, or alternatively, a link budget for one or more uplink messages of the initial access procedure (e.g., Msg3, Msg4 acknowledgment (ACK)) may degrade when the network entity is unable to combine multiple digital ports.

Accordingly, techniques described herein may enable a UE, a network entity, or both, to determine one or more precoders (e.g., an uplink precoder, a downlink precoder, or both) prior to completion of (e.g., before and/or during) an initial access procedure, which may result in improved coverage, reliability, spectrum efficiency, or any combination thereof (e.g., as compared to determining the one or more precoders after completion of the initial access procedure). In some cases, the UE, the network entity, or both, may determine the one or more precoders based on one or more channel state information reference signals (CSI-RS). For example, the UE may receive the one or more CSI-RS prior to a first uplink message (e.g., Msg1, MsgA) of the initial access procedure and may determine an uplink precoder based on measurement of the one or more CSI-RS. Additionally, the network entity may determine a downlink precoder based on measurement of one or more uplink messages of the initial access procedure (e.g., Msg1, MsgA, Msg3), based on a CSI report transmitted by the UE via the first uplink message (e.g., or via Msg3), or both.

Additionally, or alternatively, the UE, the network entity, or both, may determine the one or more precoders based on one or more sounding reference signals (SRSs). For example, the UE may transmit the one or more SRSs after at least the first uplink message of the initial access procedure and the network entity may determine the downlink precoder based on the one or more SRSs. In some cases, the UE may transmit the one or more SRSs after the first uplink message (e.g., Msg1, MsgA) of the initial access procedure, where the first uplink message indicates one or more parameters associated with the one or more SRSs. In some other cases, the UE may transmit the one or more SRSs after a second uplink message (e.g., Msg3) of the initial access procedure, where a first downlink message (e.g., Msg2, MsgB) of the initial access procedure indicates one or more parameters associated with the one or more SRSs. In either case, the UE may additionally determine the uplink precoder based on an indication of the uplink precoder from the network entity (e.g., via Msg2 or Msg 4), based on a preceding downlink message (e.g., Msg2 or Msg4), or both.

Additionally, or alternatively, the UE, the network entity, or both, may determine the one or more precoders based on the one or more SRSs and the one or more CSI-RSs. That is, the network entity may transmit the one or more CSI-RSs before the first message of the initial access procedure and the UE may determine the uplink precoder based on the one or more CSI-RSs. Thus, the UE may apply the uplink precoder to transmission of the first message of the initial access procedure and, after transmission of the first message, may transmit the one or more SRSs. Thus, the network entity may determine the downlink precoder based on the one or more SRSs.

Thus, the UE, the network entity, or both, may communicate (e.g., transmit or receive) one or more messages of the initial access procedure based on the uplink precoder, the downlink precoder, or both, determined prior to completion of the initial access procedure based on determining the uplink precoder, the downlink precoder, or both, prior to completion of the initial access procedure.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to early precoding for initial access.

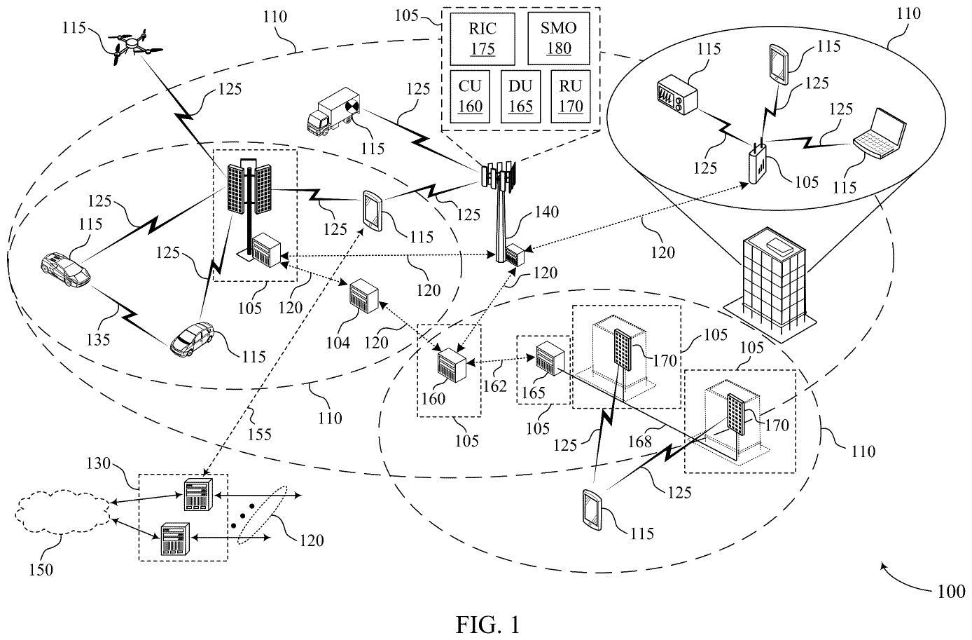

FIG. 1 shows an example of a wireless communications system 100 that supports early precoding for initial access in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support early precoding for initial access as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ⋅N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications systems 100 may support one or more initial access procedures, which may similarly be referred to as random access procedures, to establish initial access between a UE 115 and a network entity 105. For example, the UE 115 and the network entity 105 may support a four-step random access procedure, a two-step random access procedure, or both. In a four-step random access procedure, the UE 115 may transmit a first message (e.g., in a time domain) of the four-step random access procedure to the network entity 105, which may be referred to as Msg1 (e.g., preamble transmission). In such cases, Msg1 may include a random access preamble (e.g., from a set of random access preamble) and may be transmitted via a physical random access channel (PRACH). The network entity 105 may transmit, in response to Msg1, a first downlink message (e.g., in the time domain) of the four-step random access procedure, which may be referred to as Msg2 (e.g., random access response (RAR)), where Msg2 includes a timing advance (TA) command for timing adjustment, a random access preamble identifier (RAPID), an uplink grant, or any combination thereof. The UE 115 may transmit, in response to Msg2 (e.g., using the uplink grant), a second uplink message (e.g., in the time domain) of the four-step random access procedure, which may be referred to as Msg3. In such cases, the UE 115 may transmit Msg3 via a physical uplink control channel (PUSCH), and Msg3 may include an RRC message (e.g., RRCRequest), data, or both. After processing Msg3, the network entity 105 may transmit, in response to Msg3, a second downlink message (e.g., in the time domain) of the four-step random access procedure, where Msg4 includes MAC data to be used by the UE 115 for contention resolution. That is, Msg4 (e.g., a contention resolution message) may include an identifier of the UE 115, confirming that the network entity 105 has correctly identified the UE 115 and contention has been resolved. Msg4 may additionally include an indication of a cell-radio network temporary identifier (C-RNTI).

In a two-step random access procedure, the UE 115 may transmit a first message (e.g., in the time domain) of the two-step random access procedure, which may be referred to as MsgA, and the network entity 105 may transmit, in response to MsgA, a first downlink message (e.g., in the time domain) of the two-step random access procedure, which may be referred to as MsgB. In such cases, MsgA may include information carried in Msg1 and Msg3 of the four-step random access procedure and MsgB may include information carried in Msg2 and Msg4 of the four-step random access procedure. For example, MsgA (e.g., transmitted via the PRACH) may include a random access preamble transmission (e.g., MsgA PRACH) and a PUSCH transmission (e.g., MsgA PUSCH).

In some cases, the wireless communications system 100 may support techniques to enable a UE 115, a network entity 105, or both, to determine one or more precoders (e.g., an uplink precoder, a downlink precoder, or both) prior to completion of (e.g., before and/or during) an initial access procedure, which may result in improved coverage, reliability, spectrum efficiency, or any combination thereof (e.g., as compared to determining the one or more precoders after completion of the initial access procedure). In some cases, the UE 115, the network entity 105, or both, may determine the one or more precoders based on one or more CSI-RSs. For example, the UE 115 may receive the one or more CSI-RSs prior to a first uplink message (e.g., Msg1, MsgA) of the initial access procedure and may determine an uplink precoder based on measurement of the one or more CSI-RS. Additionally, the network entity 105 may determine a downlink precoder based on measurement of one or more uplink messages of the initial access procedure (e.g., Msg1, MsgA, Msg3), based on a CSI report transmitted by the UE 115 via the first uplink message (e.g., or via Msg3), or both.

Additionally, or alternatively, the UE 115, the network entity 105, or both, may determine the one or more precoders based on one or more SRSs. For example, the UE 115 may transmit the one or more SRSs after at least the first uplink message of the initial access procedure and the network entity 105 may determine the downlink precoder based on the one or more SRSs. In some cases, the UE 115 may transmit the one or more SRSs after the first uplink message (e.g., Msg1, MsgA) of the initial access procedure, where the first uplink message indicates one or more parameters associated with the one or more SRSs. In some other cases, the UE 115 may transmit the one or more SRSs after a second uplink message (e.g., Msg3) of the initial access procedure, where a first downlink message (e.g., Msg2, MsgB) of the initial access procedure indicates one or more parameters associated with the one or more SRSs. In either case, the UE 115 may additionally determine the uplink precoder based on an indication of the uplink precoder from the network entity 105 (e.g., via Msg2 or Msg 4), based on a preceding downlink message (e.g., Msg2 or Msg4), or both.

Additionally, or alternatively, the UE 115, the network entity 105, or both, may determine the one or more precoders based on the one or more SRSs and the one or more CSI-RSs. For example, the network entity 105 may transmit the one or more CSI-RSs before the first message of the initial access procedure and the UE 115 may determine the uplink precoder based on the one or more CSI-RSs. Thus, the UE 115 may apply the uplink precoder to transmission of the first message of the initial access procedure and, after transmission of the first message, may transmit the one or more SRSs. Accordingly, the network entity 105 may determine the downlink precoder based on the one or more SRSs.

Thus, the UE 115, the network entity 105, or both, may communicate (e.g., transmit or receive) one or more messages of the initial access procedure based on the uplink precoder, the downlink precoder, or both, determined prior to completion of the initial access procedure based on determining the uplink precoder, the downlink precoder, or both, prior to completion of the initial access procedure.

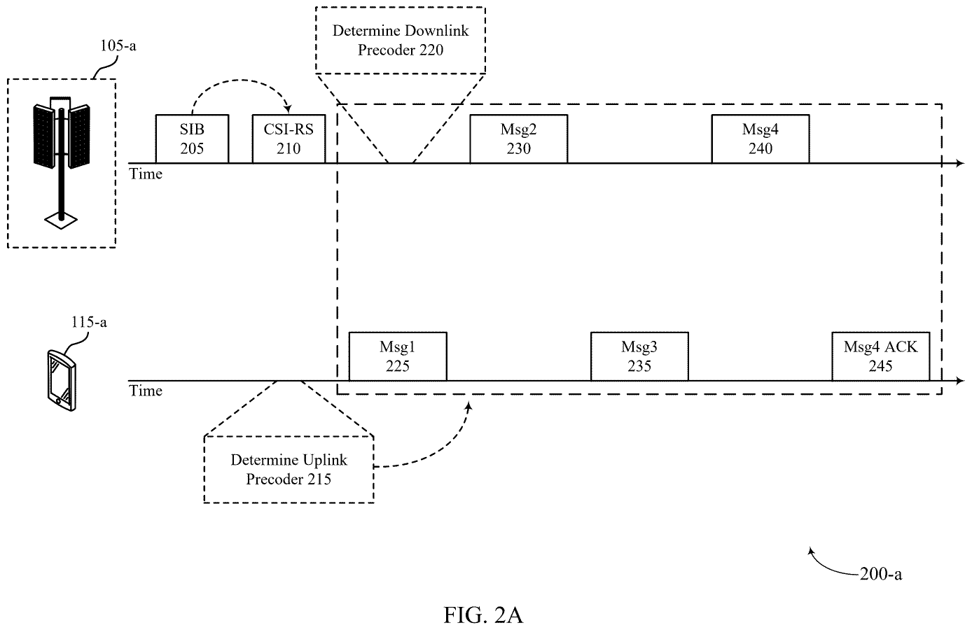

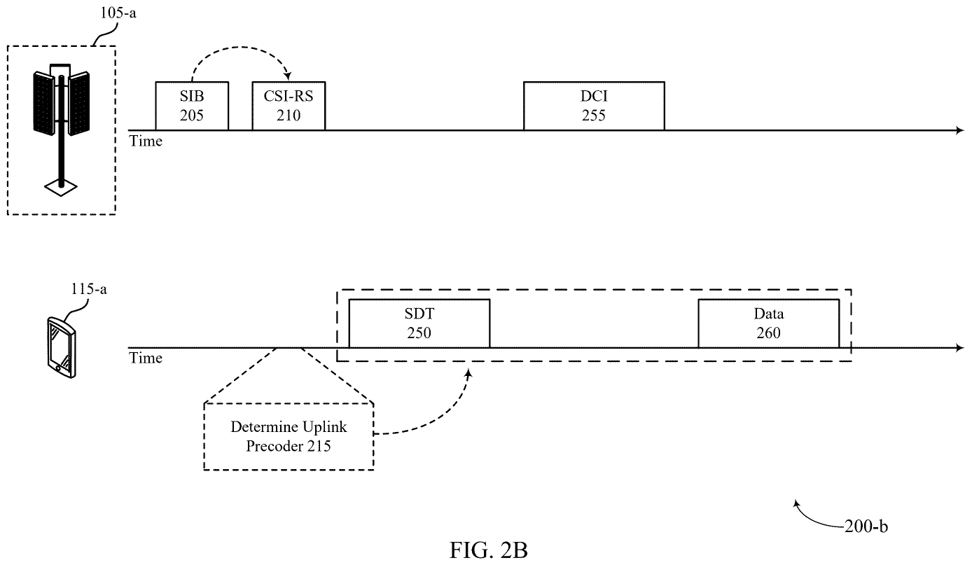

FIGS. 2A and 2B shows examples of wireless communications systems 200 (e.g., a wireless communications system 200-a, a wireless communications system 200-b) that supports early precoding for initial access in accordance with one or more aspects of the present disclosure. In some cases, the wireless communications systems 200 may implement or be implemented by aspects of the wireless communications system 100. For example, the wireless communications systems 200 may include one or more UEs 115 (e.g., a UE 115-a) and one or more network entities 105 (e.g., a network entity 105-a), which may be examples of the corresponding devices as described herein. In some cases, the UE 115-a may be in an idle state (e.g., RRC_IDLE) or an inactive state (e.g., RRC_INACTIVE).

Wireless communications systems, such as the wireless communications systems 200, may support communications between one or more UEs 115, such as the UE 115-a, and one or more network entities 105, such as the network entity 105-a, via multiple wireless channels, including one or more uplink channels, one or more downlink channels, or both. In some cases, the wireless communications systems 200 may experience one or more coverage bottlenecks due to one or more wireless channels (e.g., of the multiple wireless channels). For example, one or more wireless channels may be associated with a lower threshold pathloss (e.g., MAPL) than one or more other wireless channels, such that communications via the wireless communications systems 200 may experience delays (e.g., a backup in communications) via the one or more wireless channels associated with the lower threshold pathloss. For example, for an 8 gigahertz (GHz) channel, coverage bottlenecks may occur for unicast PUSCH with 1 Mbps in uplink based on the unicast PUSCH with 1 Mbps being associated with a lowest threshold pathloss out of a set of uplink channels and for unicast PDSCH with 30 Mbps in downlink based on the unicast PDSCH with 30 Mbps being associated with a lowest threshold pathloss out of a set of downlink channels. In such cases, the coverage bottlenecks may be reduced (e.g., relaxed) by reducing a data rate.

Additionally, one or more other coverage bottlenecks may occur via one or more initial access-related channels, which may be one or more channels used by the UE 115-a, the network entity 105-a, or both, during an initial access procedure (e.g., as observed in 4 GHz, 8 GHz, and 28 GHz). For example, the network entity 105-a may broadcast one or more downlink messages of the initial access procedure via a PDSCH, a PDCCH, or both, in accordance with a precoder that may result in a lower communication performance than may be supported by the PDSCH, the PDCCH, or both (e.g., a sub-optimal precoder). Additionally, or alternatively, a link budget for one or more uplink messages of the initial access procedure (e.g., Msg3, Msg4 ACK) may degrade when the network entity 105-a is unable to combine multiple digital ports.

Thus, in some cases, the wireless communications systems 200 may support one or more coverage enhancement schemes for initial access channels. However, the one or more coverage enhancement schemes may be based on channel repetitions, which may be associated with increased overhead, reductions in network energy savings, may not be supported for all transmissions, or any combination thereof. Additionally, or alternatively, the one or more coverage enhancements may become less efficient as a quantity of channel repetitions increases due to degradations on channel estimation (e.g., in lower signal-to-noise (SNR)). For example, an SNR for broadcast PDSCH reduces by 4 dBs (e.g., instead of 6 dBs) when the quantity of channel repetitions increases from 4 to 16.

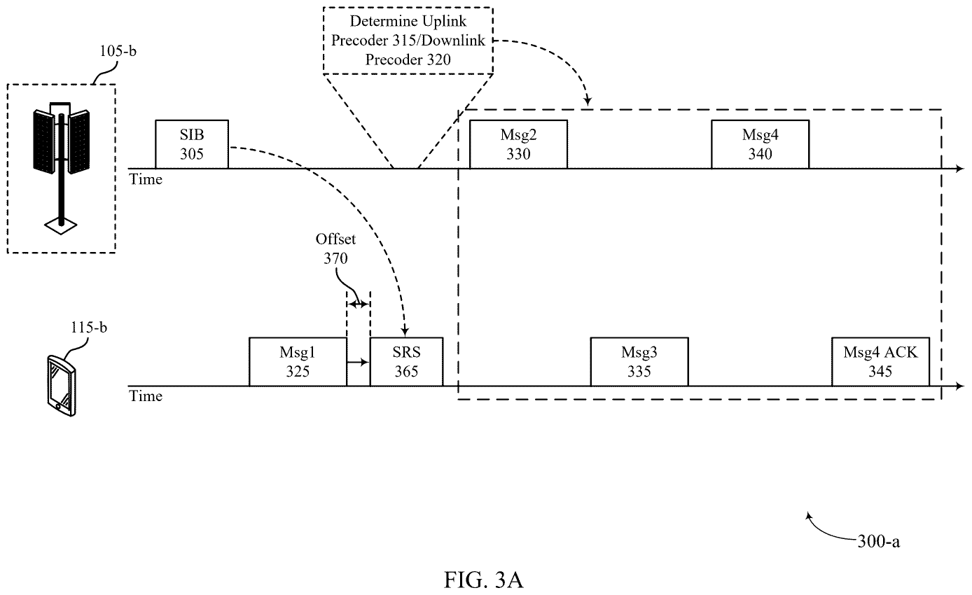

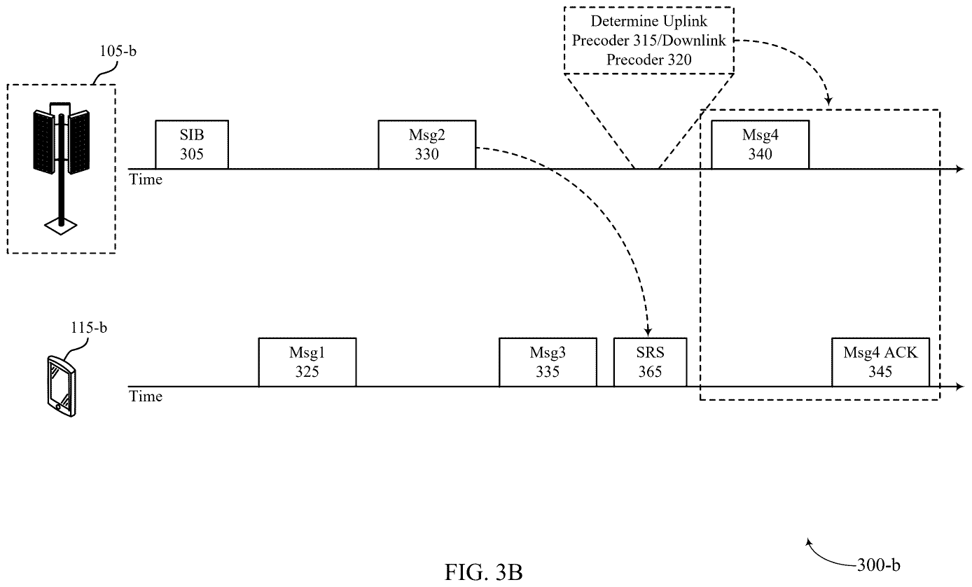

Accordingly, techniques described herein may enable the UE 115-a, the network entity 105-a, or both, to determine one or more precoders (e.g., an uplink precoder 215, a downlink precoder 220, or both) prior to completion of an initial access procedure (e.g., instead of after RRC setup completion) to further enable the UE 115-a, the network entity 105-a, or both, to communicate one or more messages of the initial access procedure (e.g., a Msg1 225, a Msg2 230, a Msg3 235, a Msg4 240, a Msg4 ACK 245, one or more other initial access messages) in accordance with the one or more precoders. In such cases, the UE 115-a, the network entity 105-a, or both, may determine the one or more precoders based on one or more CSI-RSs 210 (e.g., X-port CSI-RSs 210), as described with reference to FIGS. 2A and 2B, based on one or more SRSs (e.g., Y-port SRSs), as described with reference to FIGS. 3A and 3B, based on one or more synchronization signal blocks (SSBs) (e.g., X-port SSBs), or any combination thereof, where each CSI-RS 210, each SRS, or both, are associated with one SSB. Communicating the one or more messages of the initial access procedure in accordance with the one or more precoders may result in improved coverage, reliability, spectrum efficiency, or any combination thereof (e.g., as compared to determining the one or more precoders after completion of the initial access procedure) for the initial access procedure (e.g., until RRC setup completion).

In some cases, as described with reference to the wireless communications system 200-a and the wireless communications system 200-b, the network entity 105-a may broadcast one or more CSI-RSs 210 (e.g., X-port CSI-RSs 210) for early precoder determination (e.g., for use in determining the uplink precoder 215, the downlink precoder 220, or both). For example, the network entity 105-a may transmit a control message, such as a system information block (SIB) 205, indicating configuration information associated with the one or more CSI-RSs 210. The network entity 105-a may broadcast, in accordance with the configuration information (e.g., via a control resource set (CORESET) 0), the one or more CSI-RSs 210 prior to a first uplink message of an initial access procedure, such as the Msg1 225 (e.g., or a MsgA) as depicted with reference to FIG. 2A (e.g., in accordance with a four-step random access procedure). As such, the UE 115-a may measure (e.g., perform CSI measurement of) the one or more CSI-RSs 210 to determine the uplink precoder 215 and may apply the uplink precoder 215 to one or more target uplink messages of a set of uplink messages associated with the random access procedure.

In such cases, the network entity 105-a may indicate, to the UE 115-a (e.g., via the SIB 205), whether the UE 115-a is to apply the uplink precoder 215 to all or a subset of the set of uplink messages associated with the initial access procedure (e.g., the Msg1 225, MsgA PRACH, MsgA PUSCH, the Msg3 235). That is, the network entity 105-a may indicate whether the one or more target uplink messages include all or the subset of the set of uplink messages associated with the initial access procedure. For example, the UE 115-a may apply the uplink precoder 215 to the Msg1 225 (e.g., or the MsgA) if the network entity 105-a supports coherent combining across reception antennas. Additionally, or alternatively, a threshold duration (e.g., time interval) between the one or more CSI-RSs 210 and the one or more target uplink messages (e.g., using the uplink precoder 215) may be indicated to the UE 115-a by the network entity 105-a, may be preconfigured at the UE 115-a, may be based on a capability of the UE 115-a, or any combination thereof. Additionally, or alternatively, the network entity 105-a may indicate, to the UE 115-a, whether the uplink precoder 215 is wideband or sub-band. For example, when the uplink precoder 215 is sub-band, the UE 115-a may use the uplink precoder 215 corresponding to a sub-band containing (e.g., associated with) the one or more target uplink messages.

For downlink, the network entity 105-a may determine the downlink precoder 220 based on one or more uplink messages (e.g., from the set of uplink messages associated with the initial access procedure), based on feedback from the UE 115-a, or both. For example, in some cases, the network entity 105-a may implicitly determine the downlink precoder 220 based on measurement of an uplink message of the set of uplink messages associated with the initial access procedure, such as the Msg1 225 (e.g., PRACH), one or more demodulation reference signals (DMRSs) of the Msg3 235, or both (e.g., or MsgA PRACH, MsgA PUSCH, or both). For example, the network entity 105-a may derive the downlink precoder 220 for the Msg2 230, the Msg4 240, one or more other downlink messages, or any combination thereof, based on measurement of the Msg1 225.

Additionally, or alternatively, the UE 115-a may transmit a CSI report via an uplink message of the set of uplink messages associated with the initial access procedure, such as the Msg1 (e.g., Msg1 PRACH, MsgA PRACH), a corresponding random access occasion (RO), the Msg3 235 (e.g., Msg3 PUSCH, MsgA PUSCH), or any combination thereof, such that the network entity 105-a may determine the downlink precoder 220 based on the CSI report. For example, the network entity 105-a may derive the downlink precoder 220 for the Msg4 240, one or more other downlink messages, or both, based on a CSI report received via the Msg3 235. In such cases, the CSI report may include one or more metrics associated with the one or more CSI-RSs 210, such as one or more channel quality indicators (CQIs), one or more precoding matrix indicators (PMIs), one or more ranks, one or more layer indicators (e.g., wideband or sub-band), or any combination thereof. Additionally, or alternatively, the network entity 105-a may indicate, to the UE 115-a, one or more sub-bands to measure (e.g., and report on) the one or more CSI-RSs 210, which may be candidate sub-bands for scheduling of one or more subsequent downlink messages.

Though described in the context of a four-step random access procedure, this is not to be regarded a limitation of the present disclosure. In this regard, the first uplink message of the initial access procedure may be a MsgA of a two-step random access procedure (e.g., MsgA PRACH, MsgA PUSCH) and a first downlink message of the initial access procedure may be a MsgB of the two-step random access procedure.

In some examples, as described with reference to FIG. 2B, the UE 115-a may apply the uplink precoder 215 (e.g., derived from the one or more CSI-RSs 210) to configured grant (CG)-based small data transmission (SDT), scheduling request (SR)-less uplink data transmission (e.g., in connected mode), CG-based RRC setup, CG-based RRC resume (e.g., if a timing advance (TA) is known), or any combination thereof. For example, the UE 115-a may apply the uplink precoder 215 to an SDT 250, data 260 (e.g., after a DCI 255), or both. In such cases, the SDT 250 may be a CG-SDT including an RRC resume request, a first subset of uplink data, a buffer status report, or any combination thereof, and the data 260 may include a remaining subset of the uplink data.

In some cases, a CG associated with the SDT 250 may be dedicated to the UE 115-a, or may be shared with (e.g., applicable for) multiple UEs 115. Additionally, or alternatively, the UE 115-a may acquire a TA prior to the SDT 250 via the initial access procedure (e.g., in an absence of data), stored (e.g., memorized) at the UE 115-a (e.g., in a case of fixed wireless access (FWA)), or both. In some cases, the CG may include CSI for the DCI 255 (e.g., precoded DCI), PDSCH, or both (e.g., a shorter CORESET for an SDT search space). Additionally, or alternatively, the UE 115-a may adapt an MCS for the CG with a combined uplink reference signal receive power (RSRP) estimated based on measurement of the one or more CSI-RSs 210.

In some cases, the UE 115-a may determine one or more first parameters for measurement of the one or more CSI-RSs 410 based on an indication (e.g., of a configuration or rule) from the network entity 105-a, based on pre-configuration of the UE 115-a, or both. In some examples, the network entity 105-a may broadcast an indication of the one or more first parameters (e.g., the configuration) via the SIB 405 (e.g., SIB1), via a master information block (MIB), or both. In some cases, one or more first parameters may include time behavior of the one or more CSI-RSs 410 (e.g., periodic, semi-persistent, aperiodic). For example, for periodic time behavior or semi-persistent time behavior, the one or more first parameters may include a period, an offset (e.g., a time offset) from a reference timing (e.g., SFN=0), or both. For aperiodic time behavior, the one or more first parameters may include an offset (e.g., a time offset) from a triggering DCI, a corresponding CSI request codepoint, or both. Additionally, or alternatively, the one or more first parameters may include an X-port CSI-RS configuration, which may be associated with one or more CSI-RS resources in a CSI-RS resource set. For example, 128-port CSI-RS may be associated with (e.g., achieved by) a single 128-port CSI-RS resource or four 32-port CSI-RS resources in a CSI-RS resource set.

Additionally, or alternatively, the one or more first parameters may include, for each CSI-RS resource in a CSI-RS resource set, a total quantity of ports, a port index assignment, a time and frequency dimension per code division multiplexing (CDM) group, a multiplexed port number per CDM group, a time and frequency location per CDM group in a corresponding slot, a sequence identifier, a scrambling identifier, a quasi-co-location (QCL) source reference signal to determine a receive spatial filter, or any combination thereof. Additionally, or alternatively, the one or more first parameters may include, for the CSI-RS resource set, a subcarrier spacing (SCS), a resource set type (e.g., CSI acquisition, beam management, antenna switching, tracking reference signal (TRS)), a power offset relative to one or more other signals (e.g., SSB and PDSCH), multiplexing, or prioritization, rules with one or more other signals, an availability indicator for a corresponding window (e.g., time window, dynamically signaled in a broadcast DCI), or any combination thereof. In some cases, the one or more first parameters may additionally, or alternatively, indicate whether one or more additional CSI-RS resource sets are configured for interference measurement (e.g., ZP CSI-RS resource set, NZP CSI-RS resource set, or both, may additionally be configured for interference measurement).

In some cases, the UE 115-a may determine one or more second parameters for the CSI report (e.g., early CSI report) based on an indication (e.g., of a configuration or rule) from the network entity 105-a, based on pre-configuration of the UE 115-a, or both. In some examples, the network entity 105-a may broadcast an indication of the one or more second parameters (e.g., the configuration) via the SIB 405 (e.g., SIB1), via a MIB, or both. For example, the one or more second parameters may include one or more metrics to be reported (e.g., CQI, PMI, rank indicator, layer indicator, L1-RSRP, L1-signal-to-interference noise ratio (SINR), time domain channel correlation), a PMI codebook type (e.g., type1, type2), one or more restrictions on the one or more metrics (e.g., fixed or max rank number, only consider a subset of candidate beams in a codebook), a bandwidth to be reported (e.g., wideband, whole initial uplink bandwidth part (BWP), partial BWP, sub-bands, multiple sections of a BWP), one or more reporting resources (e.g., PUSCH in Msg3 235, PUCCH scheduled by Msg4 240), a reporting format (e.g., long PUCCH format, short PUCCH, format), a reporting time behavior (e.g., aperiodic, semi-persistent, periodic), or any combination thereof.

As described herein, early precoding may result in improved coverage, reliability, spectrum efficiency, or any combination thereof, by utilizing multiple (e.g., a threshold, or large, quantity) downlink digital ports, uplink digital ports, or both, prior to completion of RRC setup. For example, a rank of the downlink precoder 220, the uplink precoder 215, or both, may be 1 to improve coverage. As an illustrative example, 64 ports at the network entity 105-a and both 2 transmission ports and 4 reception ports at the UE 115-a (e.g., for frequency range 1 (FR 1)) may result in 21 dB digital beamforming gain in uplink and 24 dB digital beamforming gain in downlink. In another example, 128 ports at the network entity 105-a and both 4 transmission ports and 8 reception ports at the UE 115-a (e.g., for frequency range 3 (FR 3)) may result in 27 dB digital beamforming gain in uplink and 30 dB digital beamforming gain in downlink. Other port combinations may be considered with reference to the techniques described herein.

As described herein, X and Y may be any positive integer. Additionally, techniques described herein with reference to the one or more CSI-RSs 210 may be applied with reference to one or more SSBs (e.g., X-port SSBs).

Though described in the context of CSI-RS 410, this is not to be regarded as a limitation of the preset disclosure. In this regard, the techniques described herein may similarly be applicable to SSB (e.g., X-port SSB).

FIGS. 3A and 3B shows examples of wireless communications systems 300 (e.g., a wireless communications system 300-a, a wireless communications system 300-b) that supports early precoding for initial access in accordance with one or more aspects of the present disclosure. In some cases, the wireless communications systems 300 may implement or be implemented by aspects of the wireless communications system 100, the wireless communications systems 200, or both. For example, the wireless communications systems 300 may include one or more UEs 115 (e.g., a UE 115-b) and one or more network entities 105 (e.g., a network entity 105-b), which may be examples of the corresponding devices as described herein. In some cases, the UE 115-b may be in an idle state (e.g., RRC_IDLE) or an inactive state (e.g., RRC_INACTIVE).

In some cases (e.g., for TDD), as described with reference to the wireless communications system 300-a and the wireless communications system 300-b, the UE 115-b may broadcast one or more SRSs 365 (e.g., Y-port SRSs 365) for early precoder determination (e.g., for use in determining an uplink precoder 315, a downlink precoder 320, or both). For example, in some cases, as depicted in the wireless communications system 300-a, the network entity 105-b may transmit a control message, such as a SIB 305, indicating configuration information associated with the one or more SRSs 365. Thus, the UE 115-b may broadcast, after a first uplink message of the initial access procedure (e.g., following a PRACH transmission), such as a Msg1 325 as depicted in FIG. 3A (e.g., or a MsgA PRACH), the one or more SRSs 365 and the network entity 105-b may determine (e.g., derive) the uplink precoder 315, the downlink precoder 320, or both, based on the one or more SRSs 365. In some cases, the UE 115-b may transmit the one or more SRSs 365 in accordance with an offset 370 between an end of the Msg1 325 and a beginning of the one or more SRSs 365.

For example, for downlink, the network entity 105-b may determine (e.g., learn) a MIMO channel based on the one or more SRSs 365 and may determine the downlink precoder 320 based on the MIMO channel and based on assuming that the UE 115-b may use optimal vector combining across receive antennas at the UE 115-b (e.g., maximum ratio combining (MRC)). Thus, the network entity 105-a may apply the downlink precoder 320 to a first downlink message of the initial access procedure, such as a Msg2 330 (e.g., or a MsgB), a second downlink message of the initial access procedure, such as a Msg4 340, one or more other downlink messages, or any combination thereof.

For uplink, the network entity 105-b may determine the uplink precoder 315 based on the MIMO channel (e.g., assuming channel reciprocity) determined in accordance with the one or more SRSs 365 and may transmit an indication of the uplink precoder 315 to the UE 115-b via one or more downlink messages of the initial access procedure. Thus, the UE 115-b may apply the uplink precoder 315 to one or more uplink messages of the initial access procedure, such a second uplink message of the initial access procedure, such as a Msg3 335, a third uplink message of the initial access procedure, such as a Msg4 ACK 345, one or more other uplink message, or any combination thereof. For example, the network entity 105-b may transmit an indication of the uplink precoder 315 via the Msg2 330, such that the UE 115-a may apply the uplink precoder 315 to the Msg3 335, the Msg4 ACK 345, or both.

Additionally, or alternatively, the UE 115-b may determine the uplink precoder 315 based on one or more downlink messages (e.g., preceding downlink messages) of the initial access procedure if the one or more downlink messages are in a same bandwidth as the one or more uplink messages of the initial access procedure (e.g., channel reciprocity is present). For example, the UE 115-b may derive the uplink precoder 315 (e.g., for Msg3 335) based on one or more DMRS of the Msg2 330 and may apply the uplink precoder 315 to the Msg3 335 based on the one or more DMRS of the Msg2 330 and the Msg3 335 being associated with a same bandwidth (e.g., a TDD carrier).

In some examples, one or more first parameters (e.g., a subset of a set of parameters) associated with the one or more SRSs 365 may be based on one or more second parameters of the Msg1 325. The one or more first parameters may include a starting time of the one or more SRSs 365, a resource block (RB) range associated with the one or more SRSs 365, a comb offset associated with the one or more SRSs 365, a root sequence index associated with the one or more SRSs 365, a cyclic shift per port associated with the one or more SRSs 365, or any combination thereof. The one or more second parameters may include a preamble indicated via the Msg1 325, one or more time resources associated with reception of the Msg1 325, one or more frequency resources associated with reception of the Msg1 325, or any combination thereof. In some cases, one or more resources associated with the Msg1 325 (e.g., candidate PRACH resources) and one or more resources associated with the one or more SRSs 365 may be 1-to-1 mapped based on respective orders in corresponding resource pools. Additionally, or alternatively, the one or more resources associated with Msg1 325 may be ordered based on preamble indices within each RO first, then RO indices in frequency, then RO indies in time. Additionally, or alternatively, the one or more resources associated with the one or more SRSs 365 may be ordered based on SRS comb offset indices within each RB range first, then SRS root sequence indices for each comb offset, then RB range indices, and then symbol range indices.

Additionally, or alternatively, as depicted in FIG. 3B, the UE 115-b may transmit the one or more SRSs 365 after the first downlink message of the initial access procedure, such as the Msg2 330, after the second uplink message of the initial access procedure, such as the Msg3 335, or both. In such cases, the Msg2 330 (e.g., Msg2 PDCCH or Msg2 PDSCH) may schedule the one or more SRSs 365 (e.g., indicate the one or more first parameters). Thus, for downlink, as described herein, the network entity 105-b may derive the downlink precoder 320 based on the one or more SRSs 365 and may apply the downlink precoder 320 to the Msg4 340, one or more other downlink messages, or both. For uplink, as described herein, the network entity 105-b may determine the uplink precoder 315 based on the MIMO channel (e.g., assuming channel reciprocity) determined in accordance with the one or more SRSs 365 and, in some cases, may transmit an indication of the uplink precoder 315 to the UE 115-b via one or more downlink messages of the initial access procedure, such as the Msg4 340. Thus, the UE 115-b may apply the uplink precoder 315 to one or more uplink messages of the initial access procedure, such as the Msg3 335, one or more other uplink message, or both. Additionally, or alternatively, the UE 115-b may determine the uplink precoder 315 based on one or more downlink messages (e.g., preceding downlink messages) of the initial access procedure. For example, the UE 115-b may derive the uplink precoder 315 (e.g., for the Msg4 ACK 345) based on one or more DMRSs of the Msg4 340 and may apply the uplink precoder 315 to the Msg4 ACK 345. In some cases, the one or more first parameters (e.g., the subset of the set of parameters) associated with the one or more SRSs 365 may be indicated to the UE 115-b via one or more downlink messages prior to the one or more SRSs 365, such as the Msg2 330 (e.g., Msg2 PDSCH or PDCCH), one or more uplink messages prior to the one or more SRSs 365, such as the Msg3 335, or both.

In some cases, the UE 115-a may determine one or more third parameters (e.g., the same as or different than the one or more first parameters) for transmission of the one or more SRSs 465 based on an indication (e.g., of a configuration or rule) from the network entity 105-b, based on pre-configuration of the UE 115-b, or both. In some examples, the network entity 105-b may broadcast an indication of the one or more third parameters (e.g., the configuration) via the SIB 305 (e.g., SIB1), via a MIB, or both. The one or more third parameters may include time behavior associated with the one or more SRSs 465 (e.g., aperiodic, semi-persistent, periodic), a quantity of SRS resource sets, or any combination thereof. Additionally, or alternatively, the one or more third parameters may include, for each SRS resource per SRS resource set, a port number, a root sequence index, a cyclic shift, a total quantity of symbols, a symbol repetition factor, a symbol locations in a corresponding slot, a RB range, a frequency hopping pattern across different repetitions, a time and frequency location per repetition, a QCL source reference signal to determine a spatial transmit filter, a time offset from a reference signal (e.g., the Msg2 330 or the Msg4 340 PDCCH/PDSCH, the Msg1 325, MsgA PRACH, the Msg3 335 or MsgA PUSCH, triggering the SRS), or any combination thereof. Additionally, or alternatively, the one or more third parameters may include, for each SRS resource set, TA information, one or more power control parameters (e.g., P0, alpha, a closed loop index, a path loss reference signal), an SRS resource set type (e.g., antenna switching, codebook, non-codebook, beam management), or any combination thereof.

Though described in the context of a four-step random access procedure, this is not to be regarded as a limitation of the present disclosure. In this regard, the first uplink message of the initial access procedure may be a MsgA of a two-step random access procedure (e.g., MsgA PRACH, MsgA PUSCH) and the first downlink message of the initial access procedure may be a MsgB of the two-step random access procedure.

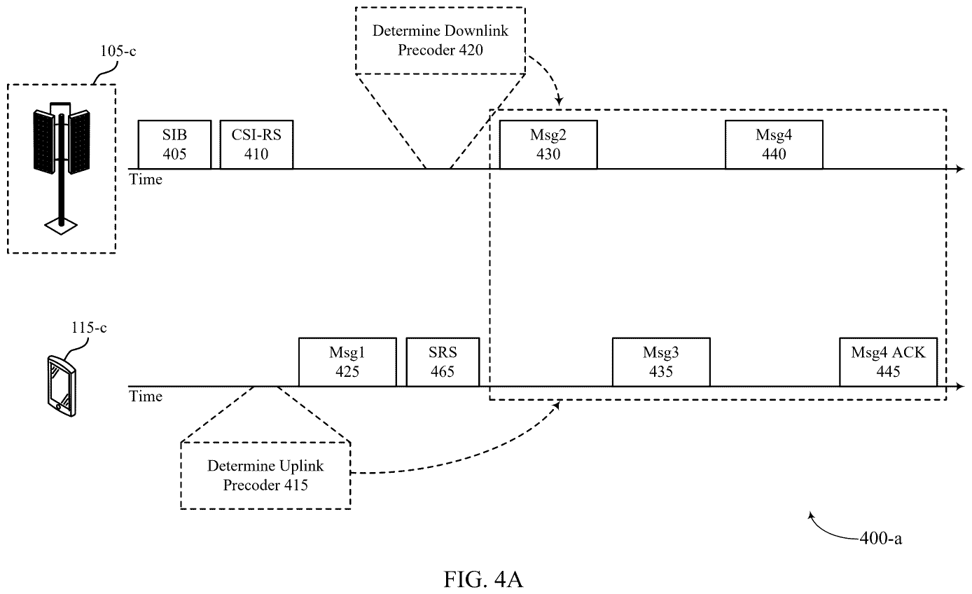

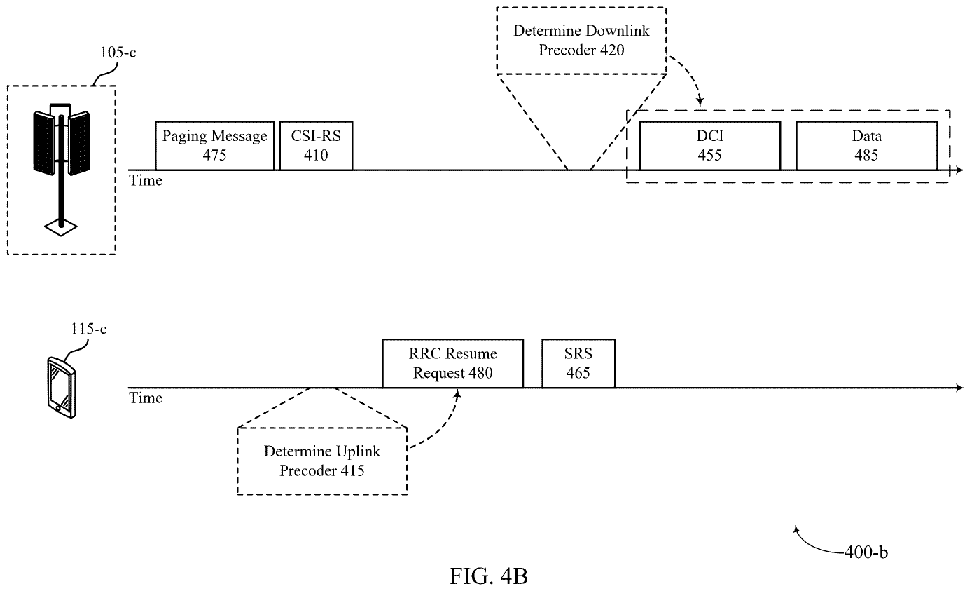

FIGS. 4A and 4B shows examples of wireless communications systems 400 (e.g., a wireless communications system 400-a, a wireless communications system 400-b) that supports early precoding for initial access in accordance with one or more aspects of the present disclosure. In some cases, the wireless communications systems 400 may implement or be implemented by aspects of the wireless communications system 100, the wireless communications systems 200, the wireless communications systems 300, or any combination thereof. For example, the wireless communications systems 400 may include one or more UEs 115 (e.g., a UE 115-c) and one or more network entities 105 (e.g., a network entity 105-c), which may be examples of the corresponding devices as described herein. In some cases, the UE 115-c may be in an idle state (e.g., RRC_IDLE) or an inactive state (e.g., RRC_INACTIVE).

In some cases (e.g., for TDD), as described with reference to the wireless communications system 400-a and the wireless communications system 400-b, the UE 115-c may broadcast on one or more SRSs 365 (e.g., Y-port SRSs 365) and the network entity 105-c may broadcast one or more CSI-RSs 410 (e.g., X-port CSI-RSs 410) for early precoder determination (e.g., for use in determining an uplink precoder 415, a downlink precoder 420, or both). For example, in some cases, as depicted in the wireless communications system 400-a, the network entity 105-c may transmit a control message, such as a SIB 405, indicating configuration information associated with the one or more CSI-RSs 410. Thus, the network entity 105-c may broadcast, after the SIB 405, the one or more CSI-RSs 410 in accordance with the configuration information (e.g., prior to a first uplink message of the initial access procedure). The UE 115-c may initiate transmission of the first uplink message of the initial access procedure, such as a Msg1 425 (e.g., PRACH transmission), followed by broadcast of the one or more SRSs 465 (e.g., 1-port precoded SRS with rank-1 uplink precoder). In such cases, the UE 115-c may broadcast the one or more SRSs 465 in accordance with the uplink precoder 415 determined based on the one or more CSI-RSs 410. The UE 115-c may additionally apply the uplink precoder 415 to one or more uplink messages (e.g., remaining uplink messages) of the initial access procedure, such as a Msg3 435, a Msg4 ACK 445, one or more other uplink messages, or any combination thereof. The network entity 105-c may derive the downlink precoder 420 (e.g., rank-1 downlink precoder) based on the one or more SRSs 465 and may apply the downlink precoder to one or more downlink messages (e.g., remaining downlink messages) of the initial access procedure, such as a Msg2 430, a Msg4 440, one or more other downlink messages, or any combination thereof.

In some cases, the UE 115-c may support one or more SRSs communication schemes to reduce SRS resource overhead, reduce SRS interference from other UEs 115, or both. For example, according to a first SRS communication scheme (e.g., Scheme 1), transmission of the Msg1 425 (e.g., PRACH transmissions) from multiple different UEs 115 may map to a same set of time and frequency resources or respective overlapped sets of time and frequency resources for respective SRS transmissions. In such cases, respective SRS transmissions by the multiple different UEs 115 may be separated by different SRS root sequences, different cyclic shifts, different comb offsets, or any combination thereof. Additionally, or alternatively, according to a second SRS communication scheme (e.g., Scheme 2), a set of time and frequency resources for transmission of the SRS 465 by the UE 115-c may be dynamically reserved (e.g., instead of semi-statically reserved). For example, the UE 115-c may transmit the one or more SRSs 465 in a first uplink slot (e.g., applicable uplink slot) that is associated with an offset that satisfies a threshold offset (e.g., maximum time offset). That is, the threshold offset may be between an end of transmission of the Msg1 425 and a beginning of transmission of the one or more SRSs 465, such that the first uplink slot may be a first uplink slot that is associated with an offset from the end of transmission of the Msg1 425 that is greater than the threshold offset. The first uplink slot may be an SRS resource that is dynamically reserved by the Msg1 425. Additionally, or alternatively, according to a third SRS communication scheme (e.g., Scheme 3), the UE 115-c may transmit the one or more SRSs 465 when coverage is less than a threshold coverage. For example, the UE 115-c may transmit the one or more SRSs 465 when a highest RSRP associated with one or more SSBs is less than a threshold RSRP, when a quantity of repetitions of the Msg1 425 (e.g., PRACH repetitions) is less than a threshold quantity of repetitions, or both.

Though described in the context of a four-step random access procedure, this is not to be regarded a limitation of the present disclosure. In this regard, the first uplink message of the initial access procedure may be MsgA of a two-step random access procedure (e.g., MsgA PRACH, MsgA PUSCH) and a first downlink message of the initial access procedure may be MsgB of the two-step random access procedure (e.g., MsgB).

In some examples, as described with reference to FIG. 4B, the UE 115-c may receive the one or more CSI-RSs 410 after a paging message 475 (e.g., for downlink data) and may apply the uplink precoder 415 derived based on the one or more CSI-RSs 410 to CG-based RRC setup, CG-based RRC resume, or both (e.g., if a TA is known by the UE 115-c). For example, the UE 115-c may derive the uplink precoder 415 based on the one or more CSI-RSs 410 and may apply the uplink precoder 415 to an RRC resume request 480 (e.g., CG-Resume). In such cases, the RRC resume request 480 may be associated with (e.g., triggered by) a CG that may be dedicated to the UE 115-c, or may be shared with multiple UEs 115, including the UE 115-c. Additionally, or alternatively, the TA may be acquired prior to the RRC resume request 480 via the initial access procedure (e.g., in an absence of data), stored (e.g., memorized) at the UE 115-c (e.g., in a case of FWA), or both.

In some cases, the CG may additionally trigger transmission of the one or more SRSs 465. For example, the UE 115-c may transmit the one or more SRSs 465 (e.g., 1-port SRS) after the RRC resume request 480, and the network entity 105-c may derive the downlink precoder 420 (e.g., rank-1 downlink precoder) based on the one or more SRSs 465. Thus, the network entity 105-c may apply the downlink precoder 420 to one or more following downlink messages (e.g., following downlink data), such as a DCI 455, data 485 (e.g., RRC resume with downlink data), or both.

In some cases, as described herein with reference to FIGS. 2A, 2B, 3A, 3B, 4A, and 4B, measurement of the one or more CSI-RSs 410, transmission of a CSI report during an initial access procedure (e.g., early CSI report), transmission of the one or more SRSs 465, or any combination thereof, may be subject to one or more capabilities of the UE 115-c. For example, in some cases, all used parameters per feature may be supported by the UE 115-c. That is, a threshold quantity of CSI-RS ports, a threshold quantity of CSI-RS resources, one or more CSI metrics to be reported, a threshold quantity of SRS ports, a threshold quantity of SRS resources, or any combination thereof, configured by the network entity 105-c may be supported by all UEs 115, including the UE 115-c. Additionally, or alternatively, the UE 115-c may transmit a capability message indicative of one or more capabilities of the UE 115-c associated with measurement of the one or more CSI-RSs 410, transmission of a CSI report during an initial access procedure, transmission of the one or more SRSs 465, or any combination thereof. For example, the capability message may indicate a threshold quantity of supported ports, a threshold quantity of supported resources, one or more supported metrics for CSI reporting, or any combination thereof. The UE 115-c may transmit capability message via the Msg1 425, the Msg3 435, or both (e.g., or via MsgA).

Additionally, or alternatively, without transmitting the capability message, the UE 115-c may perform measurement of the one or more CSI-RSs 410, transmission of a CSI report during an initial access procedure, transmission of the one or more SRSs 465, or any combination thereof, in accordance with the one or more capabilities of the UE 115-c. For example, for measurement of the one or more CSI-RSs 410 (e.g., early CSI-RS measurement), the UE 115-c may measure a first quantity of ports (e.g., X′ ports) out of a first total quantity of ports (e.g., X ports) if a first threshold quantity of ports supported by the UE 115-c is the first quantity of ports. Additionally, or alternatively, for transmission of a CSI report during an initial access procedure (e.g., early CSI reporting), the UE 115-c may report one or more supported metrics with a corresponding report content or format indicated to the network entity 105-c. Additionally, or alternatively, transmission of the one or more SRSs 465 (e.g., early SRS transmission), the UE 115-c may transmit measure a second quantity of ports (e.g., Y′ ports) out of a second total quantity of ports (e.g., Y ports) if a second threshold quantity of ports supported by the UE 115-c is the second quantity of ports. In such cases, the network entity 105-c may detect the transmitted second quantity of ports. Additionally, or alternatively, the UE 115-c may initiate an initial access procedure with the network entity 105-c (e.g., may access a cell) based on (e.g., only when) the UE 115-c supports an early precoding configuration broadcast by the network entity 105-c.

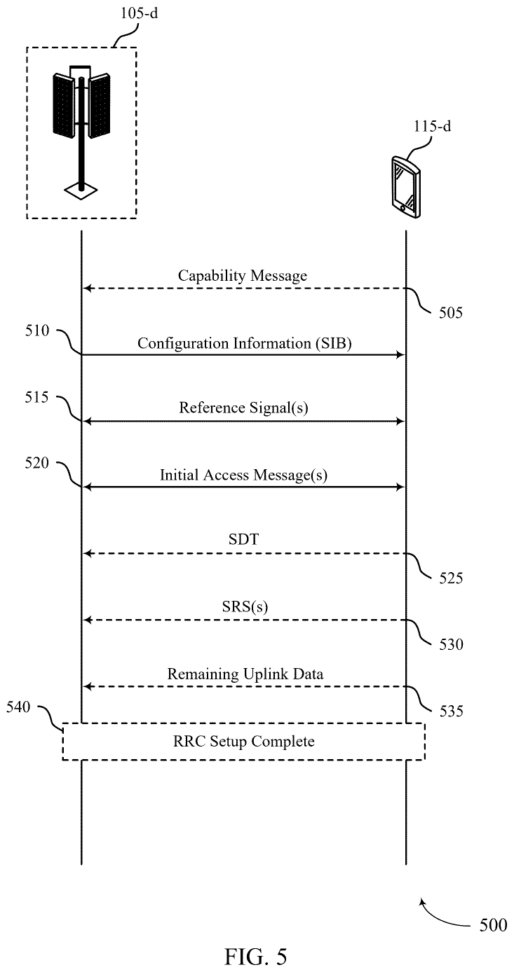

FIG. 5 shows an example of a process flow 500 that supports early precoding for initial access in accordance with one or more aspects of the present disclosure. In some cases, the process flow 500 may implement or be implemented by aspects of the wireless communications system 100, the wireless communications systems 200, the wireless communications systems 300, the wireless communications systems 400, or any combination thereof. For example, the process flow 500 may include one or more UEs 115 (e.g., a UE 115-d) and one or more network entities 105 (e.g., a network entity 105-d), which may be examples of the corresponding devices as described herein. In the following description of the process flow 500, the operations between the UE 115-d and the network entity 105-d may be communicated in a different order than the example order shown, or the operations performed by the UE 115-d and the network entity 105-d may be performed in different orders or at different times. Some operations may also be omitted from the process flow 500, and other operations may be added to the process flow 500. In some cases, the UE 115-d may be in an idle state (e.g., RRC_IDLE) or an inactive state (e.g., RRC_INACTIVE).

In some cases, at 505, the UE 115-d may transmit a capability message indicative of one or more capabilities of the UE 115-d associated with determination of one or more precoders based on one or more reference signals.

At 510, the UE 115-d may receive (e.g., via a SIB, a MIB, or both) configuration information associated with the one or more reference signals. In some examples, the configuration information (e.g., or additional control signaling) may indicate whether the UE is to apply an uplink precoder to a first uplink message of an initial access procedure (e.g., Msg1, MsgA), a second uplink message of the initial access procedure (e.g., Msg3), or both.

In some cases, the first uplink message of the initial access procedure may include an indication of the configuration information, where the configuration information is indicative of one or more first parameters associated with one or more SRSs, including a starting time, an RB range, a comb offset, a root sequence index, a cyclic shift per port, or any combination thereof.

In some examples, a first downlink message of the initial access procedure (e.g., Msg2), the second uplink message of the initial access procedure, or both, may include an indication of the configuration information, where the configuration information is indicative of the one or more first parameters associated with the one or more SRSs.

In some cases, the configuration information may include an indication of one or more second parameters associated with the one or more reference signals, where the one or more second parameters include a time behavior associated with the one or more reference signals, one or more resource sets associated with the one or more reference signals, a quantity of resources per resource set, or any combination thereof. Additionally, the configuration information may further include one or more third parameters associated with each resource set within the one or more resource sets, where the one or more third parameters include an SCS, a resource set type, a power offset, a prioritization rule associated with one or more other signals, an availability indicator associated with a time window, TA information, one or more power control parameters, a resource set type, or any combination thereof. Additionally, or alternatively, the configuration information may further include one or more fourth parameters associated each resource in the resource set, where the one or more fourth parameters include a total quantity of ports, a port index assignment, a time-frequency dimension per CDM group, a multiplexed port number per CDM group, a time-frequency location per code division multiplexing group in a corresponding slot, a sequence identifier, a scrambling identifier, a first QCL source, a first reference signal used to determine a receive spatial filter, a comb offset, a root sequence index, a cyclic shift, a total quantity of symbols, a symbol repetition factor, one or more symbol locations, an RB range, a frequency hopping pattern, one or more time-frequency locations per repetition, a second QCL source used to determine a transmit spatial filter, one or more time offsets, or any combination thereof.

At 515, the UE 115-d may communicate (e.g., transmit or receive), in accordance with the configuration information, the one or more reference signals prior to at least a first subset of a multiple messages associated with the initial access procedure, which may be referred to as initial access messages, and, at 520, may communicate (e.g., transmit or receive) at least a second subset of the multiple messages associated with the initial access procedure in accordance with one or more precoders, where the one or more precoders are based on one or more channel measurements (e.g., CSI measurements) of the one or more reference signals.

In some cases, the one or more reference signals may include one or more CSI-RSs. In such cases, communicating the one or more reference signals prior to at least the first subset of the multiple messages associated with the initial access procedure may include receiving the one or more CSI-RS prior to all of the multiple messages associated with the initial access procedure. Additionally, the one or more precoders may include the uplink precoder, and the second subset of the multiple messages associated with the initial access procedure may include the first uplink message of the initial access procedure (e.g., Msg1, MsgA), the second uplink message of the initial access procedure (e.g., Msg3), or both. Additionally, or alternatively, the one or more precoders may include a downlink precoder, and the second subset of the multiple messages associated with the initial access procedure may include comprises the first downlink message of the initial access procedure (e.g., Msg2, MsgB), a second downlink message of the initial access procedure (e.g., Msg4), or both. In some cases, the downlink precoder may be based on one or more additional channel measurements associated with the first uplink message of the initial access procedure, the second uplink message of the initial access procedure, or both. Additionally, or alternatively, the UE 115-d may transmit a report (e.g., early CSI report) indicative of one or more channel measurements (e.g., via one or more CQIs, one or more PMIs, one or more ranks, one or more layer indicators) associated with the one or more channel state information reference signals via the first uplink message of the initial access procedure, the second uplink message of the initial access procedure, or both, where the downlink precoder is based on the one or more channel measurements. In some cases, transmission of the report may be in accordance with one or more fifth parameters. In such cases, the one or more fifth parameters may include one or more metrics to be reported, a PMI codebook type, one or more restrictions associated with the one or more metrics to be reported, a reported bandwidth, one or more reporting resources, reporting time behavior, or any combination thereof.

Additionally, or alternatively, the one or more reference signals may include the one or more SRSs. In such cases, communicating the one or more reference signals prior to at least the first subset of the multiple messages associated with the initial access procedure may include transmitting the one or more SRSs after at least a first uplink message of the initial access procedure. In some cases, at least the second subset of the multiple messages associated with the initial access procedure may include the second uplink message of the initial access procedure, and one or more downlink messages of the initial access procedure (e.g., Msg2, Msg4, MsgB). In such cases, the one or more precoders may include the uplink precoder based on the one or more channel measurements of the one or more SRS, and the first downlink message of the one or more downlink messages may include an indication of the uplink precoder to be used for transmission of the second uplink message of the initial access procedure. Additionally, or alternatively, the one or more precoders may include the uplink precoder based on the first downlink message from the one or more downlink messages of the initial access procedure and based on the first uplink message and the first downlink message being associated with a same bandwidth. Additionally, or alternatively, the one or more precoders may include the downlink precoder based on the one or more SRSs and based on the UE 115-d supporting MRS.

In some cases, transmitting the one or more SRSs after at least a first uplink message of the initial access procedure may include transmitting the one or more SRSs after the first downlink message of the initial access procedure, where the first downlink message includes the configuration information associated with one or more SRSs. In such cases, the one or more precoders may include the downlink precoder based on the one or more SRS, and at least the second subset of the multiple messages associated with the initial access procedure may include at least the second downlink message of the initial access procedure. Additionally, the one or more precoders may include the uplink precoder based on the one or more channel measurements of the one or more SRS, and where the second downlink message of the initial access procedure includes an indication of the uplink precoder. Additionally, or alternatively, the one or more precoders may include uplink precoder based on the second downlink message of the initial access procedure.

Additionally, or alternatively, the one or more reference signals may include both the one or more CSI-RSs and the one or more SRSs. In such cases, communicating the one or more reference signals prior to at least the first subset of the multiple messages associated with the initial access procedure may include receiving the one or more CSI-RS prior to the first uplink message of the initial access procedure and transmitting the one or more SRSs after the first uplink message of the initial access procedure. In such cases, the one or more precoders may include the uplink precoder based on the one or more CSI-RS and the downlink precoder based on the one or more SRSs.

In some examples, a set of time and frequency resources associated with the one or more SRSs are common to multiple UEs 115, including at least the UE 115-d. Additionally, or alternatively, the one or more SRSs may be transmitted via a first slot, where an offset between the first slot and an end of the first uplink message satisfies a threshold offset. Additionally, or alternatively, transmission of the one or more SRSs may be based on a highest RSRP associated with one or more SSBs exceeding a threshold RSRP, based on a repetition number associated with the first uplink message exceeding a threshold number, or both.

In some cases, at 525, the UE 115-d may transmit an SDT in accordance with the uplink precoder of the one or more precoders based on receiving the one or more reference signals prior to the SDT. The SDT may include an RRC resume request, a BSR, a first subset of uplink data, or any combination thereof.

In some cases, the one or more references signals may include the one or more CSI-RS such that, at 530, the UE 115-d may transmit, after the SDT, the one or more SRSs, where the one or more precoders include the downlink precoder based on the one or more SRSs.

In some examples, at 535, the UE 115-d may transmit, after the SDT, a second subset of the uplink data in accordance with the uplink precoder based on the SDT including the first subset of the uplink data.

In some cases, at 540, the UE 115-d may complete the initial access procedure.

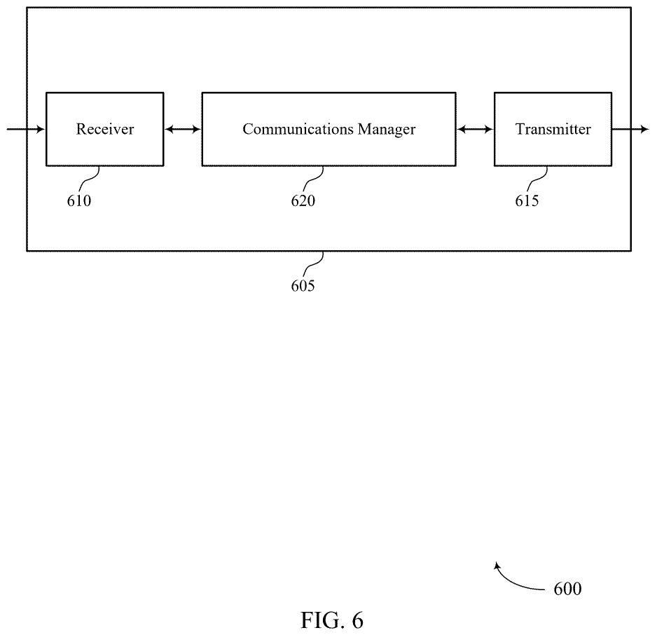

FIG. 6 shows a block diagram 600 of a device 605 that supports early precoding for initial access in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to early precoding for initial access). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to early precoding for initial access). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of early precoding for initial access as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving, while the UE is in an idle or inactive state, configuration information associated with one or more reference signals. The communications manager 620 is capable of, configured to, or operable to support a means for communicating, in accordance with the configuration information, the one or more reference signals prior to at least a first subset of a set of multiple messages associated with an initial access procedure. The communications manager 620 is capable of, configured to, or operable to support a means for communicating at least a second subset of the set of multiple messages associated with the initial access procedure in accordance with one or more precoders, where the one or more precoders are based on one or more channel measurements of the one or more reference signals.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for determining an uplink precoder, a downlink precoder, or both, prior to and/or during an initial access procedure, which may result in reduced processing, reduced power consumption, and more efficient utilization of communication resources, among other advantages.

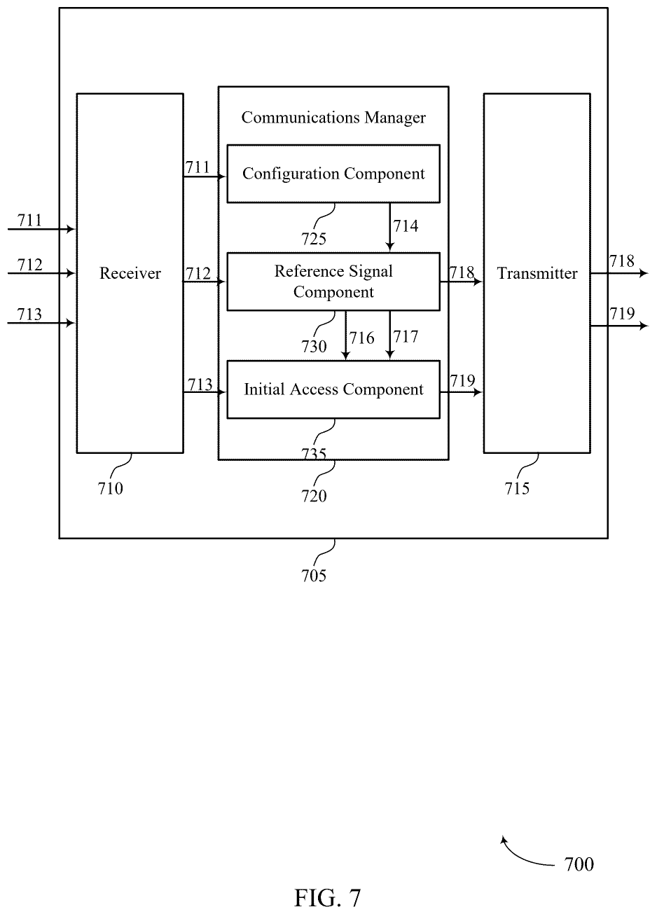

FIG. 7 shows a block diagram 700 of a device 705 that supports early precoding for initial access in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to early precoding for initial access). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to early precoding for initial access). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of early precoding for initial access as described herein. For example, the communications manager 720 may include a configuration component 725, a reference signal component 730, an initial access component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration component 725 is capable of, configured to, or operable to support a means for receiving, while the UE is in an idle or inactive state, configuration information associated with one or more reference signals. The reference signal component 730 is capable of, configured to, or operable to support a means for communicating, in accordance with the configuration information, the one or more reference signals prior to at least a first subset of a set of multiple messages associated with an initial access procedure. The initial access component 735 is capable of, configured to, or operable to support a means for communicating at least a second subset of the set of multiple messages associated with the initial access procedure in accordance with one or more precoders, where the one or more precoders are based on one or more channel measurements of the one or more reference signals.

For example, the receiver 710 of the device 705 may receive configuration information 711 associated with the one or more reference signals, including one or more CSI-RSs 712, one or more SRSs 718, or both, and may forward the configuration information 711 to the configuration component 725. In some cases, the configuration component 725 may extract (e.g., receive) one or more parameters 714 associated with the one or more reference signals and may transmit the one or more parameters 714 to the reference signal component 730. In some examples, the device 705 may receive the one or more CSI-RSs 712 via the receiver 710, which may forward the one or more CSI-RSs 712 to the reference signal component 730. Similarly, the reference signal component 730 may transmit the one or more SRSs 718, generated by the reference signal component 730, via the transmitter 715. In some cases, the reference signal component 730 may derive an uplink precoder 716 and a downlink precoder 717 based on the one or more CSI-RSs 712, the one or more SRSs 718, or both, and may communicate one or more uplink messages 719 of an initial access procedure (e.g., via the transmitter 715), one or more downlink messages 713 of the initial access procedure (e.g., via the receiver 710), or both, in accordance with the uplink precoder 716, the downlink precoder 717, or both, respectively.

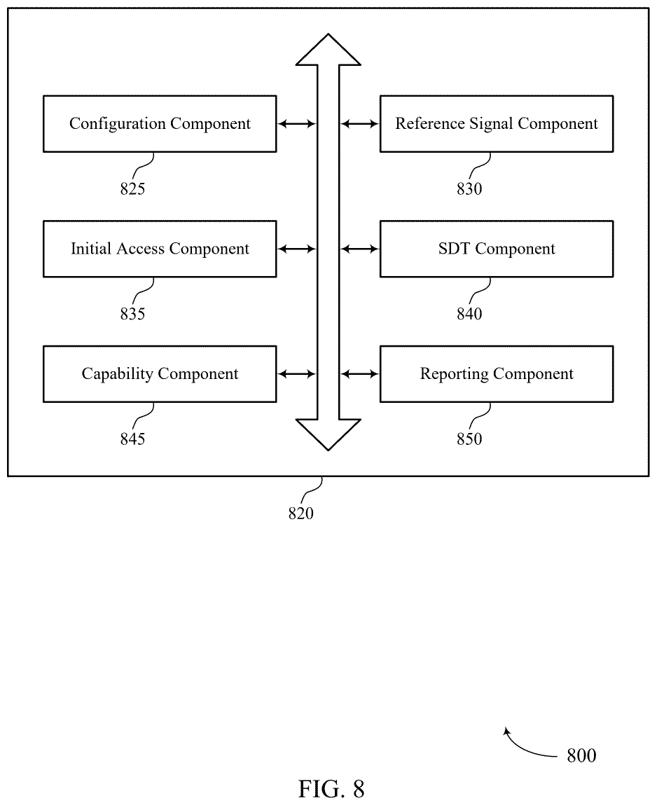

FIG. 8 shows a block diagram 800 of a communications manager 820 that supports early precoding for initial access in accordance with one or more aspects of the present disclosure. The communications manager 820 may be an example of aspects of a communications manager 620, a communications manager 720, or both, as described herein. The communications manager 820, or various components thereof, may be an example of means for performing various aspects of early precoding for initial access as described herein. For example, the communications manager 820 may include a configuration component 825, a reference signal component 830, an initial access component 835, an SDT component 840, a capability component 845, a reporting component 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration component 825 is capable of, configured to, or operable to support a means for receiving, while the UE is in an idle or inactive state, configuration information associated with one or more reference signals. The reference signal component 830 is capable of, configured to, or operable to support a means for communicating, in accordance with the configuration information, the one or more reference signals prior to at least a first subset of a set of multiple messages associated with an initial access procedure. The initial access component 835 is capable of, configured to, or operable to support a means for communicating at least a second subset of the set of multiple messages associated with the initial access procedure in accordance with one or more precoders, where the one or more precoders are based on one or more channel measurements of the one or more reference signals.

In some examples, to support communicating the one or more reference signals prior to at least the first subset of the set of multiple messages associated with the initial access procedure, the reference signal component 830 is capable of, configured to, or operable to support a means for receiving the one or more channel state information reference signals prior to all of the set of multiple messages associated with the initial access procedure.

In some examples, the one or more precoders includes an uplink precoder. In some examples, the second subset of the set of multiple messages associated with the initial access procedure includes a first uplink message of the initial access procedure, a second uplink message of the initial access procedure, or both.

In some examples, the configuration component 825 is capable of, configured to, or operable to support a means for receiving an indication of whether the UE is to apply the uplink precoder to the first uplink message of the initial access procedure, the second uplink message of the initial access procedure, or both, where the second subset of the set of multiple messages includes the first uplink message of the initial access procedure, the second uplink message of the initial access procedure, or both, based on the indication.

In some examples, the one or more precoders includes a downlink precoder. In some examples, the second subset of the set of multiple messages associated with the initial access procedure includes a first downlink message of the initial access procedure, a second downlink message of the initial access procedure, or both.

In some examples, the downlink precoder is based on one or more additional channel measurements associated with a first uplink message of the initial access procedure, a second uplink message of the initial access procedure, or both.

In some examples, the reporting component 850 is capable of, configured to, or operable to support a means for transmitting a report indicative of the one or more channel measurements associated with the one or more channel state information reference signals via a first uplink message of the initial access procedure, a second uplink message of the initial access procedure, or both, where the downlink precoder is based on the one or more channel measurements.

In some examples, the report is indicative of the one or more channel measurements based on the report include one or more channel quality indicators, one or more precoding matrix indices, one or more ranks, one or more layer indicators, or any combination thereof.

In some examples, transmission of the report is in accordance with one or more parameters. In some examples, the one or more parameters include one or more metrics to be reported, a precoding matrix indicator codebook type, one or more restrictions associated with the one or more metrics to be reported, a reported bandwidth, one or more reporting resources, reporting time behavior, or any combination thereof.

In some examples, the SDT component 840 is capable of, configured to, or operable to support a means for transmitting a small data transmission in accordance with an uplink precoder of the one or more precoders based on receiving the one or more reference signals prior to the small data transmission.

In some examples, the small data transmission includes a first subset of uplink data, and the SDT component 840 is capable of, configured to, or operable to support a means for transmitting, after the small data transmission, a second subset of the uplink data in accordance with the uplink precoder based on the small data transmission including the first subset of the uplink data.

In some examples, the small data transmission includes a radio resource control resume request, a buffer status report, or both.

In some examples, the one or more reference signals includes one or more channel state information reference signals, and the reference signal component 830 is capable of, configured to, or operable to support a means for transmitting, after the small data transmission, one or more sounding reference signals, where the one or more precoders includes a downlink precoder based on the one or more sounding reference signals.

In some examples, to support communicating the one or more reference signals prior to at least the first subset of the set of multiple messages associated with the initial access procedure, the reference signal component 830 is capable of, configured to, or operable to support a means for transmitting the one or more sounding reference signals after at least a first uplink message of the initial access procedure.

In some examples, at least the second subset of the set of multiple messages associated with the initial access procedure includes a second uplink message of the initial access procedure, and one or more downlink messages of the initial access procedure.

In some examples, the one or more precoders includes an uplink precoder based on the one or more channel measurements of the one or more sounding reference signals. In some examples, a first downlink message of the one or more downlink messages includes an indication of the uplink precoder to be used for transmission of the second uplink message of the initial access procedure.

In some examples, the one or more precoders includes an uplink precoder based on a first downlink message from the one or more downlink messages of the initial access procedure and based on the first uplink message and the first downlink message being associated with a same bandwidth.

In some examples, the one or more precoders includes a downlink precoder based on the one or more sounding reference signals and based on the UE supporting maximum ratio combining. In some examples, reception of the one or more downlink messages is in accordance with the downlink precoder.

In some examples, the first uplink message of the initial access procedure includes an indication of the configuration information. In some examples, the configuration information is indicative of one or more parameters associated with the one or more sounding reference signals. In some examples, the one or more parameters include a starting time, a resource block range, a comb offset, a root sequence index, a cyclic shift per port, or any combination thereof.

In some examples, to support transmitting the one or more sounding reference signals after at least the first uplink message of the initial access procedure, the reference signal component 830 is capable of, configured to, or operable to support a means for transmitting the one or more sounding reference signals after at least a first downlink message of the initial access procedure, where the first downlink message includes the configuration information associated with one or more sounding reference signals.

In some examples, the one or more precoders includes a downlink precoder based on the one or more sounding reference signals. In some examples, at least the second subset of the set of multiple messages associated with the initial access procedure includes at least a second downlink message of the initial access procedure.

In some examples, the one or more precoders includes an uplink precoder based on the one or more channel measurements of the one or more sounding reference signals. In some examples, a second downlink message of the initial access procedure includes an indication of the uplink precoder.

In some examples, the one or more precoders includes an uplink precoder based on a second downlink message of the initial access procedure.

In some examples, the first downlink message of the initial access procedure, a second uplink message of the initial access procedure, or both, includes an indication of the configuration information. In some examples, the configuration information is indicative of one or more parameters associated with the one or more sounding reference signals. In some examples, the one or more parameters include a starting time, a resource block range, a comb offset, a root sequence index, a cyclic shift per port, or any combination thereof.

In some examples, to support communicating the one or more reference signals prior to at least the first subset of the set of multiple messages associated with the initial access procedure, the reference signal component 830 is capable of, configured to, or operable to support a means for receiving the one or more channel state information reference signals prior to a first uplink message of the initial access procedure, where the one or more precoders includes an uplink precoder based on the one or more channel state information reference signals. In some examples, to support communicating the one or more reference signals prior to at least the first subset of the set of multiple messages associated with the initial access procedure, the reference signal component 830 is capable of, configured to, or operable to support a means for transmitting the one or more sounding reference signals after the first uplink message of the initial access procedure, where the one or more precoders includes an downlink precoder based on the one or more sounding reference signals.

In some examples, a set of time and frequency resources associated with the one or more sounding reference signals are common to a set of multiple UEs, including at least the UE.

In some examples, the one or more sounding reference signals are transmitted via a first slot. In some examples, an offset between the first slot and an end of the first uplink message satisfies a threshold offset.

In some examples, transmission of the one or more sounding reference signals is based on a highest reference signal receive power associated with one or more synchronization signal blocks exceeding a threshold reference signal receive power, based on a repetition number associated with the first uplink message exceeding a threshold number, or both.

In some examples, the configuration information includes an indication of one or more first parameters associated with the one or more reference signals. In some examples, the one or more first parameters include a time behavior associated with the one or more reference signals, one or more resource sets associated with the one or more reference signals, a quantity of resources per resource set, or any combination thereof.

In some examples, the configuration information further includes one or more second parameters associated with each resource set within the one or more resource sets. In some examples, the one or more second parameters include a subcarrier spacing, a resource set type, a power offset, a prioritization rule associated with one or more other signals, an availability indicator associated with a time window, timing advance information, one or more power control parameters, a resource set type, or any combination thereof.

In some examples, the configuration information further includes one or more second parameters associated with each resource in the resource set. In some examples, the one or more second parameters include a total quantity of ports, a port index assignment, a time-frequency dimension per code division multiplexing group, a multiplexed port number per code division multiplexing group, a time-frequency location per code division multiplexing group in a corresponding slot, a sequence identifier, a scrambling identifier, a first quasi-co-location source, a first reference signal used to determine a receive spatial filter, a comb offset, a root sequence index, a cyclic shift, a total quantity of symbols, a symbol repetition factor, one or more symbol locations, a resource block range, a frequency hopping pattern, one or more time-frequency locations per repetition, a second quasi-co-location source used to determine a transmit spatial filter, one or more time offset s, or any combination thereof.

In some examples, the configuration information is received via a system information block, a master information block, or both.

In some examples, the capability component 845 is capable of, configured to, or operable to support a means for transmitting a capability message indicative of one or more capabilities of the UE associated with determination of the one or more precoders based on the one or more reference signals.

In some examples, the capability message indicates a threshold quantity of ports supported by the UE, a threshold quantity of resources supported by the UE, one or more metrics supported by the UE, or any combination thereof.

In some examples, the one or more precoders are determined in accordance with a capability of the UE.

In some examples, communication of the one or more reference signals in accordance with the configuration information based on the UE supporting the configuration information.

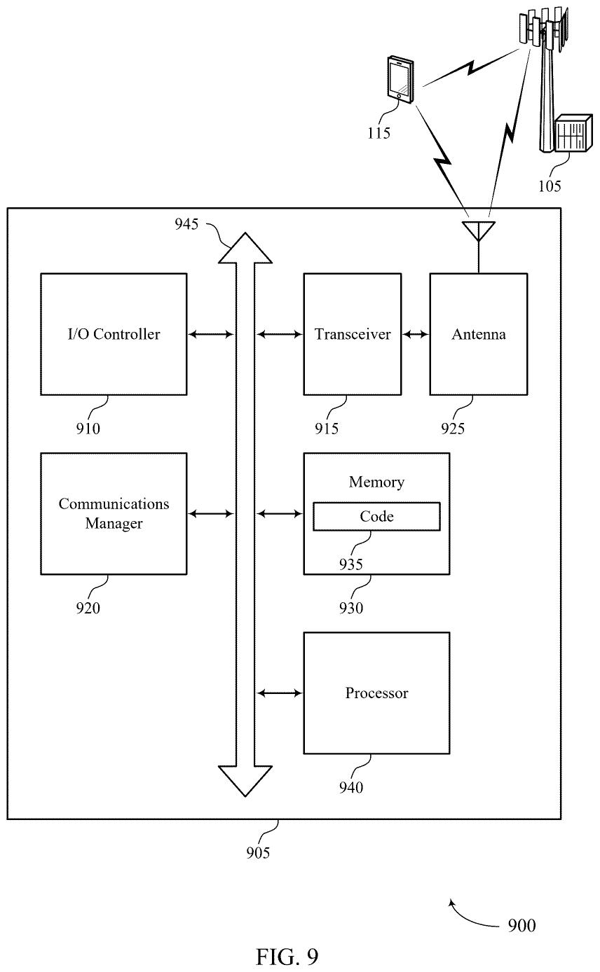

FIG. 9 shows a diagram of a system 900 including a device 905 that supports early precoding for initial access in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting early precoding for initial access). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving, while the UE is in an idle or inactive state, configuration information associated with one or more reference signals. The communications manager 920 is capable of, configured to, or operable to support a means for communicating, in accordance with the configuration information, the one or more reference signals prior to at least a first subset of a set of multiple messages associated with an initial access procedure. The communications manager 920 is capable of, configured to, or operable to support a means for communicating at least a second subset of the set of multiple messages associated with the initial access procedure in accordance with one or more precoders, where the one or more precoders are based on one or more channel measurements of the one or more reference signals.

By including or configuring the communications manager 920 in accordance with examples as described herein, the device 905 may support techniques for determining an uplink precoder, a downlink precoder, or both, prior to and/or during an initial access procedure, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of early precoding for initial access as described herein, or the at least one processor 940 and the at least one memory 930 may be otherwise configured to, individually or collectively, perform or support such operations.

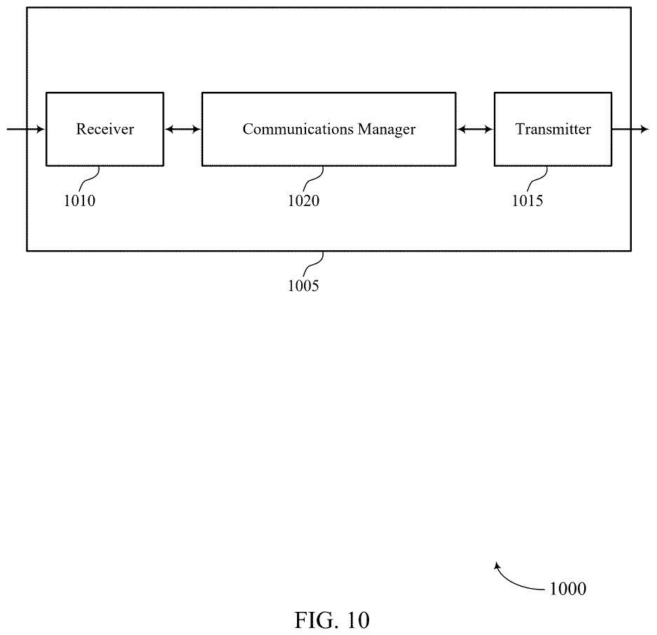

FIG. 10 shows a block diagram 1000 of a device 1005 that supports early precoding for initial access in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of early precoding for initial access as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting, to a UE that is in an idle or inactive state, configuration information associated with one or more reference signals. The communications manager 1020 is capable of, configured to, or operable to support a means for communicating, in accordance with the configuration information, the one or more reference signals prior to at least a first subset of a set of multiple messages associated with an initial access procedure. The communications manager 1020 is capable of, configured to, or operable to support a means for communicating at least a second subset of the set of multiple messages associated with the initial access procedure in accordance with one or more precoders, where the one or more precoders are based on one or more channel measurements of the one or more reference signals.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for determining an uplink precoder, a downlink precoder, or both, prior to and/or during an initial access procedure, which may result in reduced processing, reduced power consumption, and more efficient utilization of communication resources, among other advantages.

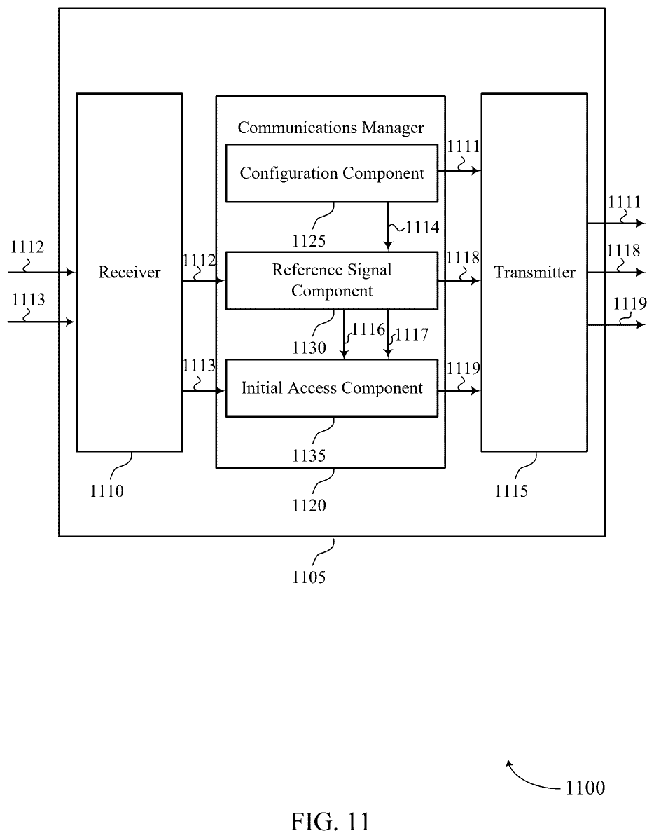

FIG. 11 shows a block diagram 1100 of a device 1105 that supports early precoding for initial access in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of early precoding for initial access as described herein. For example, the communications manager 1120 may include a configuration component 1125, a reference signal component 1130, an initial access component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The configuration component 1125 is capable of, configured to, or operable to support a means for outputting, to a UE that is in an idle or inactive state, configuration information associated with one or more reference signals. The reference signal component 1130 is capable of, configured to, or operable to support a means for communicating, in accordance with the configuration information, the one or more reference signals prior to at least a first subset of a set of multiple messages associated with an initial access procedure. The initial access component 1135 is capable of, configured to, or operable to support a means for communicating at least a second subset of the set of multiple messages associated with the initial access procedure in accordance with one or more precoders, where the one or more precoders are based on one or more channel measurements of the one or more reference signals.

For example, the device 1105 may generate configuration information 1111 associated with the one or more reference signals, including one or more SRSs 1112, one or more CSI-RSs 1118, or both, via the configuration component 1125 and may transmit the configuration information 1111 via the transmitter 1115. In some cases, the configuration component 1125 may extract (e.g., receive) one or more parameters 1114 associated with the one or more reference signals and may transmit the one or more parameters 1114 to the reference signal component 1130. In some examples, the device 1105 may receive the one or more SRSs 1112 via the receiver 1110, which may forward the one or more SRSs 1112 to the reference signal component 1130. Similarly, the reference signal component 1130 may transmit the one or more CSI-RSs 1118, generated by the reference signal component 1130, via the transmitter 1115. In some cases, the reference signal component 1130 may derive an uplink precoder 1116 and a downlink precoder 1117 based on the one or more SRSs 1112, the one or more CSI-RSs 1118, or both, and may communicate one or more uplink messages 1113 of an initial access procedure (e.g., via the receiver 1110), one or more downlink messages 1119 of the initial access procedure (e.g., via the transmitter 1115), or both, in accordance with the uplink precoder 1116, the downlink precoder 1117, or both, respectively.

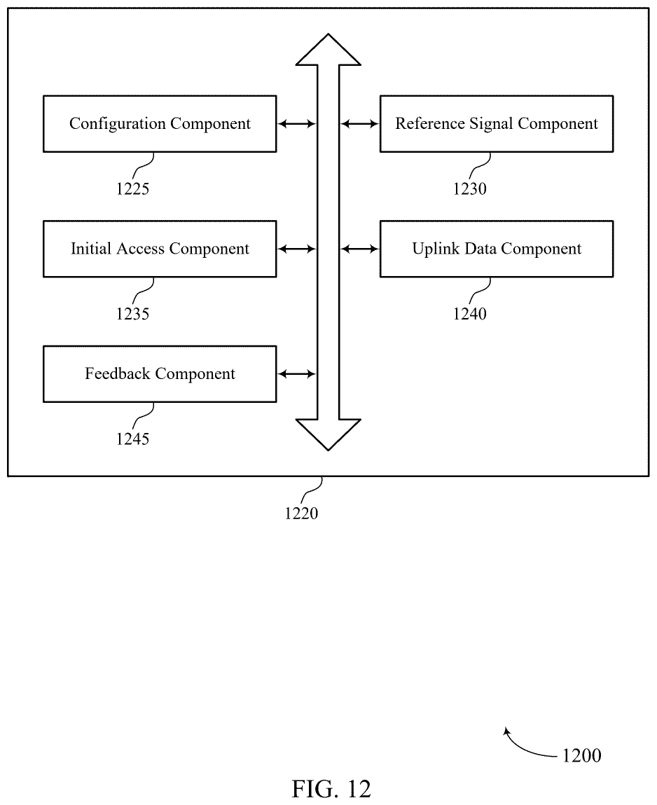

FIG. 12 shows a block diagram 1200 of a communications manager 1220 that supports early precoding for initial access in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of early precoding for initial access as described herein. For example, the communications manager 1220 may include a configuration component 1225, a reference signal component 1230, an initial access component 1235, an uplink data component 1240, a feedback component 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The configuration component 1225 is capable of, configured to, or operable to support a means for outputting, to a UE that is in an idle or inactive state, configuration information associated with one or more reference signals. The reference signal component 1230 is capable of, configured to, or operable to support a means for communicating, in accordance with the configuration information, the one or more reference signals prior to at least a first subset of a set of multiple messages associated with an initial access procedure. The initial access component 1235 is capable of, configured to, or operable to support a means for communicating at least a second subset of the set of multiple messages associated with the initial access procedure in accordance with one or more precoders, where the one or more precoders are based on one or more channel measurements of the one or more reference signals.

In some examples, to support communicating the one or more reference signals prior to at least the first subset of the set of multiple messages associated with the initial access procedure, the reference signal component 1230 is capable of, configured to, or operable to support a means for outputting the one or more channel state information reference signals prior to all of the set of multiple messages associated with the initial access procedure.

In some examples, the one or more precoders includes an uplink precoder. In some examples, the second subset of the set of multiple messages associated with the initial access procedure includes a first uplink message of the initial access procedure, a second uplink message of the initial access procedure, or both.

In some examples, the configuration component 1225 is capable of, configured to, or operable to support a means for transmitting an indication of whether the UE is to apply the uplink precoder to the first uplink message of the initial access procedure, the second uplink message of the initial access procedure, or both, where the second subset of the set of multiple messages includes the first uplink message of the initial access procedure, the second uplink message of the initial access procedure, or both, based on the indication.

In some examples, the one or more precoders includes a downlink precoder. In some examples, the second subset of the set of multiple messages associated with the initial access procedure includes a first downlink message of the initial access procedure, a second downlink message of the initial access procedure, or both.

In some examples, the downlink precoder is based on one or more additional channel measurements associated with a first uplink message of the initial access procedure, a second uplink message of the initial access procedure, or both.

In some examples, the feedback component 1245 is capable of, configured to, or operable to support a means for receiving a report indicative of the one or more channel measurements associated with the one or more channel state information reference signals via a first uplink message of the initial access procedure, a second uplink message of the initial access procedure, or both, where the downlink precoder is based on the one or more channel measurements.

In some examples, the report is indicative of the one or more channel measurements based on the report include one or more channel quality indicators, one or more precoding matrix indices, one or more ranks, one or more layer indicators, or any combination thereof.

In some examples, reception of the report is in accordance with one or more parameters. In some examples, the one or more parameters include one or more metrics to be reported, a precoding matrix indicator codebook type, one or more restrictions associated with the one or more metrics to be reported, a reported bandwidth, one or more reporting resources, reporting time behavior, or any combination thereof.

In some examples, the uplink data component 1240 is capable of, configured to, or operable to support a means for obtaining a small data transmission in accordance with an uplink precoder of the one or more precoders based on receiving the one or more reference signals prior to the small data transmission.

In some examples, the uplink data component 1240 is capable of, configured to, or operable to support a means for obtaining, after the small data transmission, a second subset of the uplink data in accordance with the uplink precoder based on the small data transmission including the first subset of the uplink data.

In some examples, the small data transmission includes a radio resource control resume request, a buffer status report, or both.

In some examples, the one or more reference signals includes one or more channel state information reference signals, and the reference signal component 1230 is capable of, configured to, or operable to support a means for obtaining, after the small data transmission, one or more sounding reference signals, where the one or more precoders includes a downlink precoder based on the one or more sounding reference signals.

In some examples, to support communicating the one or more reference signals prior to at least the first subset of the set of multiple messages associated with the initial access procedure, the reference signal component 1230 is capable of, configured to, or operable to support a means for obtaining the one or more sounding reference signals after at least a first uplink message of the initial access procedure.

In some examples, at least the second subset of the set of multiple messages associated with the initial access procedure includes a second uplink message of the initial access procedure, and one or more downlink messages of the initial access procedure.

In some examples, the one or more precoders includes an uplink precoder based on the one or more channel measurements of the one or more sounding reference signals. In some examples, a first downlink message of the one or more downlink messages includes an indication of the uplink precoder to be used for transmission of the second uplink message of the initial access procedure.

In some examples, the one or more precoders includes an uplink precoder based on a first downlink message from the one or more downlink messages of the initial access procedure and based on the first uplink message and the first downlink message being associated with a same bandwidth.

In some examples, the one or more precoders includes a downlink precoder based on the one or more sounding reference signals and based on the UE supporting maximum ratio combining. In some examples, reception of the one or more downlink messages is in accordance with the downlink precoder.

In some examples, to support obtaining the one or more sounding reference signals after at least the first uplink message of the initial access procedure, the reference signal component 1230 is capable of, configured to, or operable to support a means for obtaining the one or more sounding reference signals after at least a first downlink message of the initial access procedure, where the first downlink message includes the configuration information associated with one or more sounding reference signals.

In some examples, the one or more precoders includes a downlink precoder based on the one or more sounding reference signals. In some examples, at least the second subset of the set of multiple messages associated with the initial access procedure includes at least a second downlink message of the initial access procedure.

In some examples, the one or more precoders includes an uplink precoder based on the one or more channel measurements of the one or more sounding reference signals. In some examples, a second downlink message of the initial access procedure includes an indication of the uplink precoder.

In some examples, the one or more precoders includes an uplink precoder based on a second downlink message of the initial access procedure.

In some examples, the first downlink message of the initial access procedure, a second uplink message of the initial access procedure, or both, includes an indication of the configuration information. In some examples, the configuration information is indicative of one or more parameters associated with the one or more sounding reference signals. In some examples, the one or more parameters include a starting time, a resource block range, a comb offset, a root sequence index, a cyclic shift per port, or any combination thereof.

In some examples, to support communicating the one or more reference signals prior to at least the first subset of the set of multiple messages associated with the initial access procedure, the reference signal component 1230 is capable of, configured to, or operable to support a means for outputting the one or more channel state information reference signals prior to a first uplink message of the initial access procedure, where the one or more precoders includes an uplink precoder based on the one or more channel state information reference signals. In some examples, to support communicating the one or more reference signals prior to at least the first subset of the set of multiple messages associated with the initial access procedure, the reference signal component 1230 is capable of, configured to, or operable to support a means for obtaining the one or more sounding reference signals after the first uplink message of the initial access procedure, where the one or more precoders includes an downlink precoder based on the one or more sounding reference signals.

In some examples, a set of time and frequency resources associated with the one or more sounding reference signals are common to a set of multiple UEs, including at least the UE.

In some examples, the one or more sounding reference signals are transmitted via a first slot. In some examples, an offset between the first slot and an end of the first uplink message satisfies a threshold offset.

In some examples, reception of the one or more sounding reference signals is based on a highest reference signal receive power associated with one or more synchronization signal blocks exceeding a threshold reference signal receive power, based on a repetition number associated with the first uplink message exceeding a threshold number, or both.

In some examples, the configuration information includes an indication of one or more first parameters associated with the one or more reference signals. In some examples, the one or more first parameters include a time behavior associated with the one or more reference signals, one or more resource sets associated with the one or more reference signals, a quantity of resources per resource set, or any combination thereof.

In some examples, the configuration information further includes one or more second parameters associated with each resource set within the one or more resource sets. In some examples, the one or more second parameters include a subcarrier spacing, a resource set type, a power offset, a prioritization rule associated with one or more other signals, an availability indicator associated with a time window, timing advance information, one or more power control parameters, a resource set type, or any combination thereof.

In some examples, the configuration information further includes one or more second parameters associated with each resource in the resource set. In some examples, the one or more second parameters include a total quantity of ports, a port index assignment, a time-frequency dimension per code division multiplexing group, a multiplexed port number per code division multiplexing group, a time-frequency location per code division multiplexing group in a corresponding slot, a sequence identifier, a scrambling identifier, a first quasi-co-location source, a first reference signal used to determine a receive spatial filter, a comb offset, a root sequence index, a cyclic shift, a total quantity of symbols, a symbol repetition factor, one or more symbol locations, a resource block range, a frequency hopping pattern, one or more time-frequency locations per repetition, a second quasi-co-location source used to determine a transmit spatial filter, one or more time offset s, or any combination thereof.

In some examples, the configuration information is received via a system information block, a master information block, or both.

In some examples, the feedback component 1245 is capable of, configured to, or operable to support a means for obtaining a capability message indicative of one or more capabilities of the UE associated with determination of the one or more precoders based on the one or more reference signals.

In some examples, the capability message indicates a threshold quantity of ports supported by the UE, a threshold quantity of resources supported by the UE, one or more metrics supported by the UE, or any combination thereof.

In some examples, the one or more precoders are determined in accordance with a capability of the UE.

In some examples, communication of the one or more reference signals in accordance with the configuration information based on the UE supporting the configuration information.

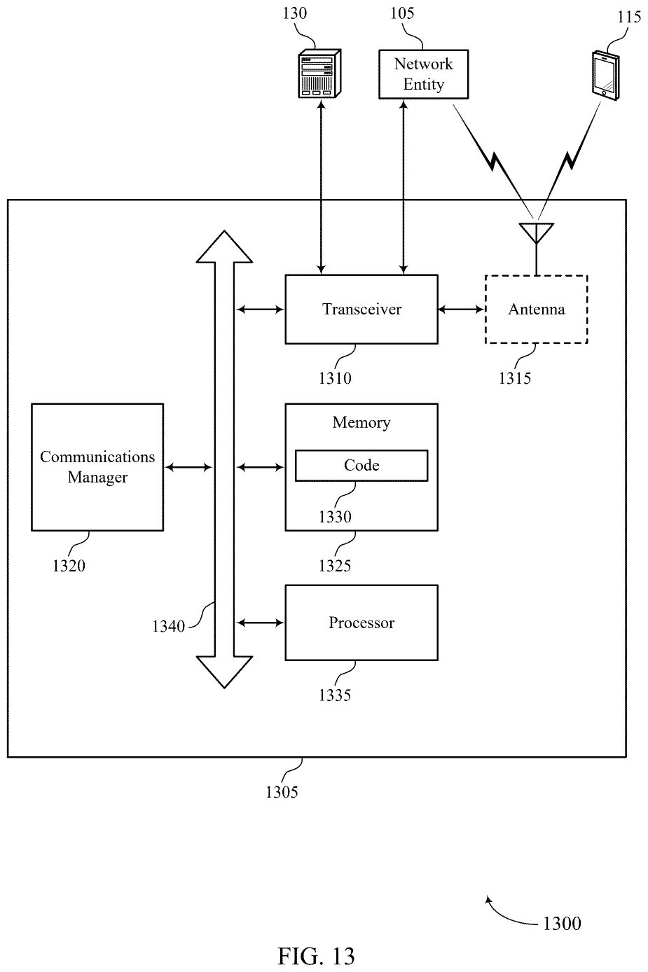

FIG. 13 shows a diagram of a system 1300 including a device 1305 that supports early precoding for initial access in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting early precoding for initial access). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting, to a UE that is in an idle or inactive state, configuration information associated with one or more reference signals. The communications manager 1320 is capable of, configured to, or operable to support a means for communicating, in accordance with the configuration information, the one or more reference signals prior to at least a first subset of a set of multiple messages associated with an initial access procedure. The communications manager 1320 is capable of, configured to, or operable to support a means for communicating at least a second subset of the set of multiple messages associated with the initial access procedure in accordance with one or more precoders, where the one or more precoders are based on one or more channel measurements of the one or more reference signals.

By including or configuring the communications manager 1320 in accordance with examples as described herein, the device 1305 may support techniques for determining an uplink precoder, a downlink precoder, or both, prior to and/or during an initial access procedure, which may result in improved communication reliability, reduced latency, improved user experience related to reduced processing, reduced power consumption, more efficient utilization of communication resources, improved coordination between devices, longer battery life, improved utilization of processing capability, among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of early precoding for initial access as described herein, or the at least one processor 1335 and the at least one memory 1325 may be otherwise configured to, individually or collectively, perform or support such operations.

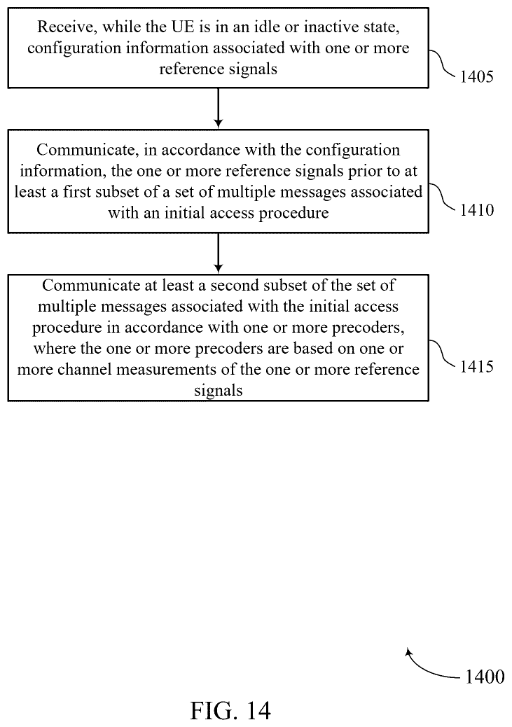

FIG. 14 shows a flowchart illustrating a method 1400 that supports early precoding for initial access in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, while the UE is in an idle or inactive state, configuration information associated with one or more reference signals. For example, the UE identifying time-frequency resources over which the control channel is transmitted, demodulating transmission over those time-frequency resources, decoding the demodulated transmission to obtain bits that indicate the downlink transmission

The operations of 1405 may be performed in accordance with examples as disclosed herein. In some examples, aspects of the operations of 1405 may be performed by a configuration component 825 as described with reference to FIG. 8.

At 1410, the method may include communicating, in accordance with the configuration information, the one or more reference signals prior to at least a first subset of a set of multiple messages associated with an initial access procedure. The operations of 1410 may be performed in accordance with examples as disclosed herein. In some examples, aspects of the operations of 1410 may be performed by a reference signal component 830 as described with reference to FIG. 8.

At 1415, the method may include communicating at least a second subset of the set of multiple messages associated with the initial access procedure in accordance with one or more precoders, where the one or more precoders are based on one or more channel measurements of the one or more reference signals. The operations of 1415 may be performed in accordance with examples as disclosed herein. In some examples, aspects of the operations of 1415 may be performed by an initial access component 835 as described with reference to FIG. 8.

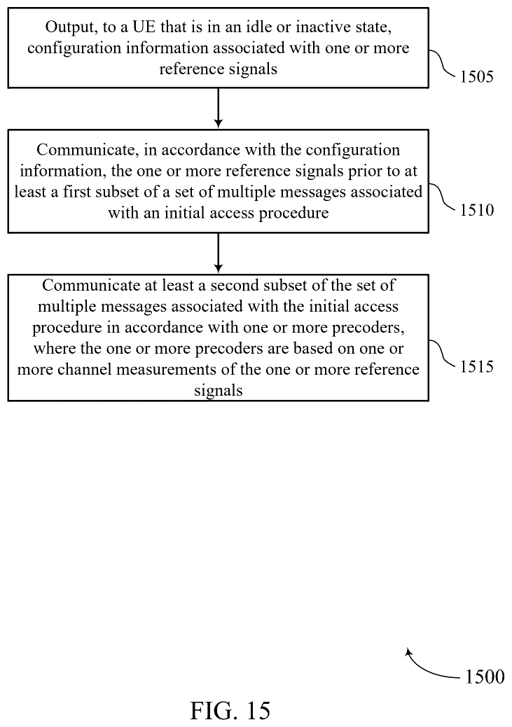

FIG. 15 shows a flowchart illustrating a method 1500 that supports early precoding for initial access in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE that is in an idle or inactive state, configuration information associated with one or more reference signals. The operations of 1505 may be performed in accordance with examples as disclosed herein. In some examples, aspects of the operations of 1505 may be performed by a configuration component 1225 as described with reference to FIG. 12.

At 1510, the method may include communicating, in accordance with the configuration information, the one or more reference signals prior to at least a first subset of a set of multiple messages associated with an initial access procedure. The operations of 1510 may be performed in accordance with examples as disclosed herein. In some examples, aspects of the operations of 1510 may be performed by a reference signal component 1230 as described with reference to FIG. 12.

At 1515, the method may include communicating at least a second subset of the set of multiple messages associated with the initial access procedure in accordance with one or more precoders, where the one or more precoders are based on one or more channel measurements of the one or more reference signals. The operations of 1515 may be performed in accordance with examples as disclosed herein. In some examples, aspects of the operations of 1515 may be performed by an initial access component 1235 as described with reference to FIG. 12.

The following provides an overview of aspects of the present disclosure:

Aspect 1: A method for wireless communications at a UE, comprising: receiving, while the UE is in an idle or inactive state, configuration information associated with one or more reference signals; communicating, in accordance with the configuration information, the one or more reference signals prior to at least a first subset of a plurality of messages associated with an initial access procedure; and communicating at least a second subset of the plurality of messages associated with the initial access procedure in accordance with one or more precoders, wherein the one or more precoders are based at least in part on one or more channel measurements of the one or more reference signals.

Aspect 2: The method of aspect 1, wherein the one or more reference signals comprise one or more CSI-RSs, and wherein communicating the one or more reference signals prior to at least the first subset of the plurality of messages associated with the initial access procedure comprises: receiving the one or more CSI-RSs prior to all of the plurality of messages associated with the initial access procedure.

Aspect 3: The method of aspect 2, wherein the one or more precoders comprises an uplink precoder, and the second subset of the plurality of messages associated with the initial access procedure comprises a first uplink message of the initial access procedure, a second uplink message of the initial access procedure, or both.

Aspect 4: The method of aspect 3, further comprising: receiving an indication of whether the UE is to apply the uplink precoder to the first uplink message of the initial access procedure, the second uplink message of the initial access procedure, or both, wherein the second subset of the plurality of messages comprises the first uplink message of the initial access procedure, the second uplink message of the initial access procedure, or both, based at least in part on the indication.

Aspect 5: The method of any of aspects 2 through 4, wherein the one or more precoders comprises a downlink precoder, and the second subset of the plurality of messages associated with the initial access procedure comprises a first downlink message of the initial access procedure, a second downlink message of the initial access procedure, or both.

Aspect 6: The method of aspect 5, wherein the downlink precoder is based at least in part on one or more additional channel measurements associated with a first uplink message of the initial access procedure, a second uplink message of the initial access procedure, or both.

Aspect 7: The method of any of aspects 5 through 6, further comprising: transmitting a report indicative of the one or more channel measurements associated with the one or more CSI-RSs via a first uplink message of the initial access procedure, a second uplink message of the initial access procedure, or both, wherein the downlink precoder is based at least in part on the one or more channel measurements.

Aspect 8: The method of aspect 7, wherein the report is indicative of the one or more channel measurements based at least in part on the report comprise one or more CQIs, one or more PMIs, one or more ranks, one or more layer indicators, or any combination thereof.

Aspect 9: The method of any of aspects 7 through 8, wherein transmission of the report is in accordance with one or more parameters, and the one or more parameters comprise one or more metrics to be reported, a PMI codebook type, one or more restrictions associated with the one or more metrics to be reported, a reported bandwidth, one or more reporting resources, reporting time behavior, or any combination thereof.

Aspect 10: The method of any of aspects 1 through 9, further comprising: transmitting an SDT in accordance with an uplink precoder of the one or more precoders based at least in part on receiving the one or more reference signals prior to the SDT.

Aspect 11: The method of aspect 10, wherein the SDT comprises a first subset of uplink data, the method further comprising: transmitting, after the SDT, a second subset of the uplink data in accordance with the uplink precoder based at least in part on the SDT comprising the first subset of the uplink data.

Aspect 12: The method of any of aspects 10 through 11, wherein the SDT comprises an RRC resume request, a BSR, or both.

Aspect 13: The method of any of aspects 10 through 12, wherein the one or more reference signals comprises one or more CSI-RSs, the method further comprising: transmitting, after the SDT, one or more SRSs, wherein the one or more precoders comprises a downlink precoder based at least in part on the one or more SRSs.

Aspect 14: The method of any of aspects 1 through 13, wherein the one or more reference signals comprise one or more SRSs, and wherein communicating the one or more reference signals prior to at least the first subset of the plurality of messages associated with the initial access procedure comprises: transmitting the one or more SRSs after at least a first uplink message of the initial access procedure.

Aspect 15: The method of aspect 14, wherein at least the second subset of the plurality of messages associated with the initial access procedure comprises a second uplink message of the initial access procedure, and one or more downlink messages of the initial access procedure.

Aspect 16: The method of aspect 15, wherein the one or more precoders comprises an uplink precoder based at least in part on the one or more channel measurements of the one or more SRSs, and a first downlink message of the one or more downlink messages comprises an indication of the uplink precoder to be used for transmission of the second uplink message of the initial access procedure.

Aspect 17: The method of any of aspects 15 through 16, wherein the one or more precoders comprises an uplink precoder based at least in part on a first downlink message from the one or more downlink messages of the initial access procedure and based at least in part on the first uplink message and the first downlink message being associated with a same bandwidth.

Aspect 18: The method of any of aspects 15 through 17, wherein the one or more precoders comprises a downlink precoder based at least in part on the one or more SRSs and based at least in part on the UE supporting maximum ratio combining, and reception of the one or more downlink messages is in accordance with the downlink precoder.

Aspect 19: The method of any of aspects 14 through 18, wherein the first uplink message of the initial access procedure comprises an indication of the configuration information, the configuration information is indicative of one or more parameters associated with the one or more SRSs, and the one or more parameters comprise a starting time, a RB range, a comb offset, a root sequence index, a cyclic shift per port, or any combination thereof.

Aspect 20: The method of any of aspects 14 through 19, wherein transmitting the one or more SRSs after at least the first uplink message of the initial access procedure further comprises: transmitting the one or more SRSs after at least a first downlink message of the initial access procedure, wherein the first downlink message comprises the configuration information associated with one or more SRSs.

Aspect 21: The method of aspect 20, wherein the one or more precoders comprises a downlink precoder based at least in part on the one or more SRSs, and at least the second subset of the plurality of messages associated with the initial access procedure comprises at least a second downlink message of the initial access procedure.

Aspect 22: The method of any of aspects 20 through 21, wherein the one or more precoders comprises an uplink precoder based at least in part on the one or more channel measurements of the one or more SRSs, and a second downlink message of the initial access procedure comprises an indication of the uplink precoder.

Aspect 23: The method of any of aspects 20 through 22, wherein the one or more precoders comprises an uplink precoder based at least in part on a second downlink message of the initial access procedure.

Aspect 24: The method of any of aspects 20 through 23, wherein the first downlink message of the initial access procedure, a second uplink message of the initial access procedure, or both, comprises an indication of the configuration information, the configuration information is indicative of one or more parameters associated with the one or more SRSs, and the one or more parameters comprise a starting time, a RB range, a comb offset, a root sequence index, a cyclic shift per port, or any combination thereof.

Aspect 25: The method of any of aspects 1 through 24, wherein the one or more reference signals comprises one or more CSI-RSs and one or more SRSs, and wherein communicating the one or more reference signals prior to at least the first subset of the plurality of messages associated with the initial access procedure comprises: receiving the one or more CSI-RSs prior to a first uplink message of the initial access procedure, wherein the one or more precoders comprises an uplink precoder based at least in part on the one or more CSI-RSs; and transmitting the one or more SRSs after the first uplink message of the initial access procedure, wherein the one or more precoders comprises an downlink precoder based at least in part on the one or more SRSs.

Aspect 26: The method of aspect 25, wherein a set of time and frequency resources associated with the one or more SRSs are common to a plurality of UEs, including at least the UE.

Aspect 27: The method of any of aspects 25 through 26, wherein the one or more SRSs are transmitted via a first slot, and an offset between the first slot and an end of the first uplink message satisfies a threshold offset.

Aspect 28: The method of any of aspects 25 through 27, wherein transmission of the one or more SRSs is based at least in part on a highest RSRP associated with one or more synchronization signal blocks exceeding a threshold RSRP, based at least in part on a repetition number associated with the first uplink message exceeding a threshold number, or both.

Aspect 29: The method of any of aspects 1 through 28, wherein the configuration information comprises an indication of one or more first parameters associated with the one or more reference signals, and the one or more first parameters comprise a time behavior associated with the one or more reference signals, one or more resource sets associated with the one or more reference signals, a quantity of resources per resource set, or any combination thereof.

Aspect 30: The method of aspect 29, wherein the configuration information further comprises one or more second parameters associated with each resource set within the one or more resource sets, and the one or more second parameters comprise an SCS, a resource set type, a power offset, a prioritization rule associated with one or more other signals, an availability indicator associated with a time window, TA information, one or more power control parameters, a resource set type, or any combination thereof.

Aspect 31: The method of any of aspects 29 through 30, wherein the configuration information further comprises one or more second parameters associated with each resource in the resource set, and the one or more second parameters comprise a total quantity of ports, a port index assignment, a time-frequency dimension per CDM group, a multiplexed port number per CDM group, a time-frequency location per CDM group in a corresponding slot, a sequence identifier, a scrambling identifier, a first QCL source, a first reference signal used to determine a receive spatial filter, a comb offset, a root sequence index, a cyclic shift, a total quantity of symbols, a symbol repetition factor, one or more symbol locations, a RB range, a frequency hopping pattern, one or more time-frequency locations per repetition, a second QCL source used to determine a transmit spatial filter, one or more time offset s, or any combination thereof.

Aspect 32: The method of any of aspects 1 through 31, wherein the configuration information is received via a SIB, a MIB, or both.

Aspect 33: The method of any of aspects 1 through 32, further comprising: transmitting a capability message indicative associated with determination of the one or more precoders based at least in part on the one or more reference signals.

Aspect 34: The method of aspect 33, wherein the capability message indicates a threshold quantity of ports supported by the UE, a threshold quantity of resources supported by the UE, one or more metrics supported by the UE, or any combination thereof.

Aspect 35: The method of any of aspects 1 through 34, wherein the one or more precoders are determined in accordance with a capability of the UE.

Aspect 36: The method of any of aspects 1 through 35, wherein communication of the one or more reference signals in accordance with the configuration information based at least in part on the UE supporting the configuration information.

Aspect 37: A method for wireless communications at a network entity, comprising: outputting, to a UE that is in an idle or inactive state, configuration information associated with one or more reference signals; communicating, in accordance with the configuration information, the one or more reference signals prior to at least a first subset of a plurality of messages associated with an initial access procedure; and communicating at least a second subset of the plurality of messages associated with the initial access procedure in accordance with one or more precoders, wherein the one or more precoders are based at least in part on one or more channel measurements of the one or more reference signals.

Aspect 38: The method of aspect 37, wherein the one or more reference signals comprise one or more CSI-RSs, and wherein communicating the one or more reference signals prior to at least the first subset of the plurality of messages associated with the initial access procedure comprises: outputting the one or more CSI-RSs prior to all of the plurality of messages associated with the initial access procedure.

Aspect 39: The method of aspect 38, wherein the one or more precoders comprises an uplink precoder, and the second subset of the plurality of messages associated with the initial access procedure comprises a first uplink message of the initial access procedure, a second uplink message of the initial access procedure, or both.

Aspect 40: The method of aspect 39, further comprising: transmitting an indication of whether the UE is to apply the uplink precoder to the first uplink message of the initial access procedure, the second uplink message of the initial access procedure, or both, wherein the second subset of the plurality of messages comprises the first uplink message of the initial access procedure, the second uplink message of the initial access procedure, or both, based at least in part on the indication.

Aspect 41: The method of any of aspects 38 through 40, wherein the one or more precoders comprises a downlink precoder, and the second subset of the plurality of messages associated with the initial access procedure comprises a first downlink message of the initial access procedure, a second downlink message of the initial access procedure, or both.

Aspect 42: The method of aspect 41, wherein the downlink precoder is based at least in part on one or more additional channel measurements associated with a first uplink message of the initial access procedure, a second uplink message of the initial access procedure, or both.

Aspect 43: The method of any of aspects 41 through 42, further comprising: receiving a report indicative of the one or more channel measurements associated with the one or more CSI-RSs via a first uplink message of the initial access procedure, a second uplink message of the initial access procedure, or both, wherein the downlink precoder is based at least in part on the one or more channel measurements.

Aspect 44: The method of aspect 43, wherein the report is indicative of the one or more channel measurements based at least in part on the report comprise one or more CQIs, one or more PMIs, one or more ranks, one or more layer indicators, or any combination thereof.

Aspect 45: The method of any of aspects 43 through 44, wherein reception of the report is in accordance with one or more parameters, and the one or more parameters comprise one or more metrics to be reported, a PMI codebook type, one or more restrictions associated with the one or more metrics to be reported, a reported bandwidth, one or more reporting resources, reporting time behavior, or any combination thereof.

Aspect 46: The method of any of aspects 37 through 45, further comprising: obtaining an SDT in accordance with an uplink precoder of the one or more precoders based at least in part on receiving the one or more reference signals prior to the SDT.

Aspect 47: The method of aspect 46, further comprising: obtaining, after the SDT, a second subset of the uplink data in accordance with the uplink precoder based at least in part on the SDT comprising the first subset of the uplink data.

Aspect 48: The method of any of aspects 46 through 47, wherein the SDT comprises an RRC resume request, a BSR, or both.

Aspect 49: The method of any of aspects 46 through 48, wherein the one or more reference signals comprises one or more CSI-RSs, the method further comprising: obtaining, after the SDT, one or more SRSs, wherein the one or more precoders comprises a downlink precoder based at least in part on the one or more SRSs.

Aspect 50: The method of any of aspects 37 through 49, wherein the one or more reference signals comprise one or more SRSs, and wherein communicating the one or more reference signals prior to at least the first subset of the plurality of messages associated with the initial access procedure comprises: obtaining the one or more SRSs after at least a first uplink message of the initial access procedure.

Aspect 51: The method of aspect 50, wherein at least the second subset of the plurality of messages associated with the initial access procedure comprises a second uplink message of the initial access procedure, and one or more downlink messages of the initial access procedure.

Aspect 52: The method of aspect 51, wherein the one or more precoders comprises an uplink precoder based at least in part on the one or more channel measurements of the one or more SRSs, and a first downlink message of the one or more downlink messages comprises an indication of the uplink precoder to be used for transmission of the second uplink message of the initial access procedure.

Aspect 53: The method of any of aspects 51 through 52, wherein the one or more precoders comprises an uplink precoder based at least in part on a first downlink message from the one or more downlink messages of the initial access procedure and based at least in part on the first uplink message and the first downlink message being associated with a same bandwidth.

Aspect 54: The method of any of aspects 51 through 53, wherein the one or more precoders comprises a downlink precoder based at least in part on the one or more SRSs and based at least in part on the UE supporting maximum ratio combining, and reception of the one or more downlink messages is in accordance with the downlink precoder.

Aspect 55: The method of any of aspects 50 through 54, wherein obtaining the one or more SRSs after at least the first uplink message of the initial access procedure further comprises: obtaining the one or more SRSs after at least a first downlink message of the initial access procedure, wherein the first downlink message comprises the configuration information associated with one or more SRSs.

Aspect 56: The method of aspect 55, wherein the one or more precoders comprises a downlink precoder based at least in part on the one or more SRSs, and at least the second subset of the plurality of messages associated with the initial access procedure comprises at least a second downlink message of the initial access procedure.

Aspect 57: The method of any of aspects 55 through 56, wherein the one or more precoders comprises an uplink precoder based at least in part on the one or more channel measurements of the one or more SRSs, and a second downlink message of the initial access procedure comprises an indication of the uplink precoder.

Aspect 58: The method of any of aspects 55 through 57, wherein the one or more precoders comprises an uplink precoder based at least in part on a second downlink message of the initial access procedure.

Aspect 59: The method of any of aspects 55 through 58, wherein the first downlink message of the initial access procedure, a second uplink message of the initial access procedure, or both, comprises an indication of the configuration information, the configuration information is indicative of one or more parameters associated with the one or more SRSs, and the one or more parameters comprise a starting time, a RB range, a comb offset, a root sequence index, a cyclic shift per port, or any combination thereof.

Aspect 60: The method of any of aspects 37 through 59, wherein the one or more reference signals comprises one or more CSI-RSs and one or more SRSs, and wherein communicating the one or more reference signals prior to at least the first subset of the plurality of messages associated with the initial access procedure comprises: outputting the one or more CSI-RSs prior to a first uplink message of the initial access procedure, wherein the one or more precoders comprises an uplink precoder based at least in part on the one or more CSI-RSs; and obtaining the one or more SRSs after the first uplink message of the initial access procedure, wherein the one or more precoders comprises an downlink precoder based at least in part on the one or more SRSs.

Aspect 61: The method of aspect 60, wherein a set of time and frequency resources associated with the one or more SRSs are common to a plurality of UEs, including at least the UE.

Aspect 62: The method of any of aspects 60 through 61, wherein the one or more SRSs are transmitted via a first slot, and an offset between the first slot and an end of the first uplink message satisfies a threshold offset.

Aspect 63: The method of any of aspects 60 through 62, wherein reception of the one or more SRSs is based at least in part on a highest RSRP associated with one or more synchronization signal blocks exceeding a threshold RSRP, based at least in part on a repetition number associated with the first uplink message exceeding a threshold number, or both.

Aspect 64: The method of any of aspects 37 through 63, wherein the configuration information comprises an indication of one or more first parameters associated with the one or more reference signals, and the one or more first parameters comprise a time behavior associated with the one or more reference signals, one or more resource sets associated with the one or more reference signals, a quantity of resources per resource set, or any combination thereof.

Aspect 65: The method of aspect 64, wherein the configuration information further comprises one or more second parameters associated with each resource set within the one or more resource sets, and the one or more second parameters comprise an SCS, a resource set type, a power offset, a prioritization rule associated with one or more other signals, an availability indicator associated with a time window, TA information, one or more power control parameters, a resource set type, or any combination thereof.

Aspect 66: The method of any of aspects 64 through 65, wherein the configuration information further comprises one or more second parameters associated with each resource in the resource set, and the one or more second parameters comprise a total quantity of ports, a port index assignment, a time-frequency dimension per CDM group, a multiplexed port number per CDM group, a time-frequency location per CDM group in a corresponding slot, a sequence identifier, a scrambling identifier, a first QCL source, a first reference signal used to determine a receive spatial filter, a comb offset, a root sequence index, a cyclic shift, a total quantity of symbols, a symbol repetition factor, one or more symbol locations, a RB range, a frequency hopping pattern, one or more time-frequency locations per repetition, a second QCL source used to determine a transmit spatial filter, one or more time offset s, or any combination thereof.

Aspect 67: The method of any of aspects 37 through 66, wherein the configuration information is received via a SIB, a MIB, or both.

Aspect 68: The method of any of aspects 37 through 67, further comprising: obtaining a capability message indicative associated with determination of the one or more precoders based at least in part on the one or more reference signals.

Aspect 69: The method of aspect 68, wherein the capability message indicates a threshold quantity of ports supported by the UE, a threshold quantity of resources supported by the UE, one or more metrics supported by the UE, or any combination thereof.

Aspect 70: The method of any of aspects 37 through 69, wherein the one or more precoders are determined in accordance with a capability of the UE.

Aspect 71: The method of any of aspects 37 through 70, wherein communication of the one or more reference signals in accordance with the configuration information based at least in part on the UE supporting the configuration information.

Aspect 72: A UE for wireless communications, comprising one or more memories storing processor-executable code, and one or more processors coupled with the one or more memories and individually or collectively operable to execute the code to cause the UE to perform a method of any of aspects 1 through 36.

Aspect 73: A UE for wireless communications, comprising at least one means for performing a method of any of aspects 1 through 36.

Aspect 74: A non-transitory computer-readable medium storing code for wireless communications, the code comprising instructions executable by one or more processors to perform a method of any of aspects 1 through 36.

Aspect 75: A network entity for wireless communications, comprising one or more memories storing processor-executable code, and one or more processors coupled with the one or more memories and individually or collectively operable to execute the code to cause the network entity to perform a method of any of aspects 37 through 71.

Aspect 76: A network entity for wireless communications, comprising at least one means for performing a method of any of aspects 37 through 71.

Aspect 77: A non-transitory computer-readable medium storing code for wireless communications, the code comprising instructions executable by one or more processors to perform a method of any of aspects 37 through 71.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, while the UE is in an idle or inactive state, a system information block that indicates configuration information associated with one or more reference signals, wherein the one or more reference signals comprise one or more channel state information reference signals, one or more sounding reference signals, or both;
communicate, in accordance with reception of the configuration information via the system information block, the one or more reference signals during an initial access procedure; and
communicate one or more additional messages in accordance with one or more precoders, wherein the one or more precoders are based at least in part on one or more channel measurements of the one or more reference signals communicated during the initial access procedure.

2. The UE of claim 1, wherein the one or more reference signals comprise the one or more channel state information reference signals, and wherein, to communicate the one or more reference signals, the one or more processors are individually or collectively operable to execute the code to cause the UE to:
receive the one or more channel state information reference signals during the initial access procedure.

3. The UE of claim 2, wherein the one or more processors are individually or collectively further operable to execute the code to cause the UE to:
transmit a report indicative of the one or more channel measurements associated with the one or more channel state information reference signals, wherein the one or more precoders comprises a downlink precoder that is based at least in part on the one or more channel measurements.

4. The UE of claim 3, wherein the one or more channel measurements comprise one or more precoder matrix indices (PMIs), one or more channel quality indicators (CQIs), or both.

5. The UE of claim 3, wherein the one or more PMIs are reporting in accordance with the report being associated with a PMI codebook Type-1.

6. The UE of claim 3, wherein the report is transmitted in accordance with a report configuration, and wherein the report configuration is received via the system information block.

7. The UE of claim 3, wherein the report is transmitted via an uplink message of the initial access procedure.

8. The UE of claim 2, wherein the one or more precoders comprise an uplink precoder that is based at least in part on the one or more channel measurements of the one or more channel state information reference signals received during the initial access procedure.

9. The UE of claim 1, wherein the one or more reference signals comprise the one or more sounding reference signals, and wherein, to communicate the one or more reference signals, the one or more processors are individually or collectively operable to execute the code to cause the UE to:
transmit the one or more sounding reference signals during the initial access procedure.

10. The UE of claim 9, wherein the one or more processors are individually or collectively operable to execute the code to cause the UE to:
receive a downlink message of the initial access procedure that triggers the one or more sounding reference signals, wherein the downlink message is Msg4 of the initial access procedure.

11. The UE of claim 9, wherein the one or more precoders comprise a downlink precoder that is based at least in part on the one or more channel measurements of the one or more sounding reference signals received during the initial access procedure.

12. The UE of claim 1, wherein the one or more processors are individually or collectively further operable to execute the code to cause the UE to:
transmit a capability message indicative of one or more capabilities of the UE associated with communication of the one or more reference signals, wherein communication of the one or more reference signals is in accordance with the one or more capabilities.

13. The UE of claim 1, wherein the one or more additional messages communicated in accordance with one or more precoders are communicated prior to completion of the initial access procedure.

14. The UE of claim 1, wherein the configuration information comprises an indication of one or more first parameters associated with the one or more reference signals, and wherein the one or more first parameters comprise a time behavior associated with the one or more reference signals, one or more resource sets associated with the one or more reference signals, a quantity of resources per resource set, or any combination thereof.

15. The UE of claim 14, wherein the configuration information further comprises one or more second parameters associated with each resource set within the one or more resource sets, and wherein the one or more second parameters comprise a subcarrier spacing, a resource set type, a power offset, a prioritization rule associated with one or more other signals, an availability indicator associated with a time window, timing advance information, one or more power control parameters, a resource set type, or any combination thereof.

16. The UE of claim 14, wherein the configuration information further comprises one or more second parameters associated with each resource in the resource set, and wherein the one or more second parameters comprise a total quantity of ports, a port index assignment, a time-frequency dimension per code division multiplexing group, a multiplexed port number per code division multiplexing group, a time-frequency location per code division multiplexing group in a corresponding slot, a sequence identifier, a scrambling identifier, a first quasi-co-location source, a first reference signal used to determine a receive spatial filter, a comb offset, a root sequence index, a cyclic shift, a total quantity of symbols, a symbol repetition factor, one or more symbol locations, a resource block range, a frequency hopping pattern, one or more time-frequency locations per repetition, a second quasi-co-location source used to determine a transmit spatial filter, one or more time offset s, or any combination thereof.

17. The UE of claim 1, wherein communication of the one or more reference signals in accordance with the configuration information based at least in part on the UE supporting the configuration information.

18. A network entity, comprising:
one or more memories storing processor-executable code; and
one or more processors coupled with the one or more memories and individually or collectively operable to execute the code to cause the network entity to:
output, to a user equipment (UE) that is in an idle or inactive state, a system information block that indicates configuration information associated with one or more reference signals, wherein the one or more reference signals comprise one or more channel state information reference signals, one or more sounding reference signals, or both;
communicate, in accordance with reception of the configuration information via the system information block, the one or more reference signals during an initial access procedure; and
communicate one or more additional messages in accordance with one or more precoders, wherein the one or more precoders are based at least in part on one or more channel measurements of the one or more reference signals communicated during the initial access procedure.

19. The network entity of claim 18, wherein the one or more reference signals comprise the one or more sounding reference signals, and wherein the one or more processors are individually or collectively operable to execute the code to cause the UE to:
receive a downlink message of the initial access procedure that triggers the one or more sounding reference signals, wherein the downlink message is Msg4 of the initial access procedure.

20. A method for wireless communications at a user equipment (UE), comprising:
receiving, while the UE is in an idle or inactive state, a system information block that indicates configuration information associated with one or more reference signals, wherein the one or more reference signals comprise one or more channel state information reference signals, one or more sounding reference signals, or both;
communicating, in accordance with reception of the configuration information via the system information block, the one or more reference signals during an initial access procedure; and
communicating one or more additional messages in accordance with one or more precoders, wherein the one or more precoders are based at least in part on one or more channel measurements of the one or more reference signals communicated during the initial access procedure.
